(19) United States
(12) Patent Application Publication
(10) Pub. No.: US 2003/0088417 A1
(43) Pub. Date: May 8, 2003

(54) Speech analysis method and speech synthesis system

(76) Inventors: Takahiro Kamai, Kyoto (JP); Yumiko Kato, Osaka (JP); Hideki Kasuya, Tochigi (JP); Takahiro Ohtsuka, Tochigi (JP)

Correspondence Address: HARNESS, DICKEY & PIERCE, P.L.C., P.O. BOX 828, BLOOMFIELD HILLS, MI, 48303, US

(21) Appl. No.: 09/955,767

(22) Filed: Sep. 19, 2001

(51) Int. Cl. G10L 13/00

(52) U.S. Cl. 704/258

(57) ABSTRACT

A speech segment to be analyzed is cut out with a window having a length of a plurality of pitch periods for RK model voicing source parameter estimation. GCIs are all estimated for a plurality of voicing source pulses. Based on such estimations, an RK model voicing source waveform is generated, its relationship with the speech segment is analyzed by ARX system identification, and then a glottal transform function is estimated. While this process repeated, when GCIs converge at a predetermined value, the identification is completed. Accordingly, a high quality analysis-synthesis system, which isolates voicing source parameters of speech signals from vocal tract parameters thereof with high accuracy, can be realized.

### BACKGROUND OF THE INVENTION

The present invention relates to a so-called speech analysis-synthesis system, which analyzes speech waveform to represent it as parameters, compresses/stores the parameters, and then synthesizes the speech using the parameters.

In a speech analysis-synthesis system, which is called “vocoder”, speech signals are effectively represented as a few parameters by modeling and the original speech is then synthesized from parameters. The speech analysis-synthesis system allows speech to be transmitted in a far smaller data amount than in the case where the speech is transmitted as waveform data. For this reason, the speech analysis-synthesis system has been used in speech communication systems. One of typical speech analysis-synthesis systems is the LPC (linear prediction coding) analysis-synthesis system.

However, a speech synthesized by an LPC vocoder or any of many other vocoders sounds unnatural as a human speech in no small way. The LPC vocoder is a model in which a sound source for voiced sounds is assumed as an impulse series and a sound source for unvoiced sounds is assumed as white noise. Thus, voiced regions of the speech have buzzy sound quality. Also, the waveform of a vocal tract vibrations is different from the impulse series and thus the effects of a spectral tilt or the like of the sound source cannot be correctly taken into account. As a result, estimation errors of vocal tract transfer characteristics increase.

Then, a method for estimating a vocal tract parameter and a voice source parameter simultaneously using a glottal waveform model as a sound source has been invented. Ding et al. have developed a pitch-synchronous speech analysis-synthesis method based on an ARX (autoregressive-exogenous) speech production model (Ding, W., Kasuya, H., and Adachi, S., “Simultaneous Estimation of Vocal Tract and Voice Source Parameters Based on an ARX Model”, IEICE Trans. Inf. & Syst., Vol. E78-D, No. 6 Jun. 1995). The method, however, has encountered deficiencies in the analysis of voices of brief pitch periodicity and transitional portions between vocalic and consonantal segments.

### SUMMARY OF THE INVENTION

According to an aspect of the present invention, a speech synthesis system, which synthesizes speech using time series data of formant parameters (including a formant frequency and a formant bandwidth) estimated based on a speech production model, includes determining the correspondence of formant parameters between adjacent frames using dynamic programming.

Preferably, in the speech synthesis system, in determining the correspondence of the formant parameters, a connection cost d_{c}(F(n), F(n+1)) and a disconnection cost d_{d}(F(k)) are obtained using the equations:

d_{c}(F(n),F(n+1))=α|F_{f}(n)−F_{f}(n+1)|+β|Fᵢ(n)−Fᵢ(n+1)|

$$\begin{matrix}{d}_{d} ( F ( k ) ) = α \vert {F}_{f} ( k ) - {F}_{f} ( k ) \vert + β \vert {F}_{i} ( k ) - ϵ \vert \\ = β \vert {F}_{i} ( k ) - ϵ \vert\end{matrix}$$

where α and β fare predetermined weight coefficients, F_{f}(n) is a formant frequency in the n^{th} frame, that Fᵢ(n) is a formant intensity in the n^{th} frame and ε is a predetermined value, and the resultant d_{c}(F(n),F(n+1))and d_{d}(F(k)) are used as costs for grid point shifting in dynamic programming.

Preferably, in the speech synthesis system, for two adjacent frames in which exists a formant which has no counterpart to be connected, a formant having the same frequency as that of the disconnected formant in one of the frames and an intensity of 0 is located in the other frame and the two adjacent frames are connected by interpolation of frequencies and intensities of both the formants according to a smooth function.

Preferably, in the speech synthesis system, the formant intensity Fᵢ(n) is calculated using

$${F}_{i} ( n ) = \{ \begin{matrix}20 {log}_{10} ( \frac{1 + {ⅇ}^{- π {F}_{b} ( n ) / {F}_{s}}}{1 - {ⅇ}^{- π {F}_{b} ( n ) / {F}_{s}}} ) , & if formant \\ 20 {log}_{10} ( \frac{1 - {ⅇ}^{- π {F}_{b} ( n ) / {F}_{s}}}{1 + {ⅇ}^{- π {F}_{b} ( n ) / {F}_{s}}} ) , & if anti \text{-} formant\end{matrix}$$

where F_{b}(n) is a formant bandwidth in the n^{th} frame and Fₛ is a sampling frequency.

Preferably, in the speech synthesis system, a vocal tract transfer function including a plurality of formants is implemented by a cascade connection of a plurality of filters, and when a formant which has no counterpart to be connected exists in the adjacent frames and thus the connection of the filters needs to be changed, a coefficient and an internally stored data of the filter in question are copied into another filter and the first filter is then overwritten with a coefficient and an internally stored data of still another filter or initialized to predetermined values.

According to another aspect of the present invention, a speech analysis method, in which a sound source parameter and a vocal tract parameter of a speech signal waveform are estimated by using a glottal source model including an RK voicing source model, includes the steps of extracting an estimated voicing source waveform using a filter which is constituted by the inverse characteristic of an estimated vocal tract transfer function, estimating a peak position corresponding to a GCI (glottal closure instance) of the estimated voicing source waveform with higher accuracy at closer time intervals than that with the sampling period by applying a quadratic function, synthesizing the GCI with a sampling position in the vicinity of the estimated peak position and thereby generating a voicing source model waveform, and time-shifting the generated voicing source model waveform with higher accuracy at closer time intervals than that with the sampling period by means of all pass filters and thereby matching the GCI with the estimated peak position.

According to still another aspect of the present invention, a speech analysis method, in which a voicing source parameter and a vocal tract parameter of a speech signal waveform are estimated by using a glottal voicing source model such as an RK model or a model defined as an extended model thereof, includes the steps of extracting an estimated voicing source waveform using filters which are constituted by the inverse characteristic of an estimated vocal tract transfer function, and assuming the first harmonic level as H1 and the second harmonic level as H2 in DFT (discrete Fourier transformation) of the estimated voicing source waveform and estimating an OQ (open quotient) from a value for HD defined as HD=H2−H1.

Preferably, in the speech analysis method, for estimating the OQ, the relation:

OQ=3.65HD−0.273HD²+0.0224HD³+50.7

is used.

### BRIEF DESCRIPTION OF THE DRAWINGS

FIG. 1 is a block diagram illustrating an ARX speech production model.

FIG. 2 is a graph showing a relationship between the OQ parameter of an RK model and the difference between the first harmonic level and the second harmonic level.

FIG. 3 is a graph showing an exemplary voicing source pulse waveform when all pass filters are used, in which (a) indicates an original waveform, (b) indicates a waveform which has been shifted by T_{d}=50 μs and (c) indicates another waveform which has been randomized by d₂=3 ms and then shifted.

FIG. 4A is a graph showing discrete formants; and FIG. 4B is a graph showing changes of spectra of the formants.

FIG. 5 is a graph showing the evaluation results of acoustic experiments.

FIG. 6 is a block diagram illustrating the configuration of a speech analysis system according to a first embodiment of the present invention.

FIG. 7 is a chart for illustrating the flow of a speech analysis process.

FIG. 8 is an illustration of how the AV parameter is obtained.

FIG. 9 is a graph illustrating the concept of polar coordinates of a complex number.

FIG. 10 is an illustration of how GCIs are estimated with high accuracy.

FIGS. 11A and 11B are illustrations of how an RK model voicing source waveform is shifted using all pass filters with higher accuracy than that in shifting by the sampling period.

FIG. 12 is a block diagram illustrating the configuration of a speech synthesis system according to a third embodiment of the present invention.

FIG. 13 is a block diagram illustrating the configuration of an RK model voicing source generation unit in a speech synthesis system according to a fourth embodiment of the present invention.

FIG. 14 is a block diagram illustrating the configuration of a speech synthesis system according to a fifth embodiment of the present invention.

FIG. 15 is a chart showing a relationship between formant frequency and bandwidth for two adjacent formants.

FIG. 16 is an illustration of the concept of a grid in which formants in Frame A are laid off as abscissas and formants in Frame B are laid off as ordinates.

FIG. 17 is an illustration of a grid in the case where all the formants are connected with their counterparts having the same number.

FIG. 18 is an illustration of a grid in the case where a disconnected formant exists.

FIG. 19 is an illustration of constraints on a shift.

FIG. 20 is a chart showing grid points through which a path can pass under the constraints of FIG. 19.

FIG. 21 is a chart for illustrating the flow of a path search process.

FIG. 22 is an illustration of exemplary costs which have been calculated by a path search process.

FIG. 23 is a chart showing how path B has been selected.

FIG. 24 is a chart showing the obtained optimum path.

FIG. 25 is a chart showing how a formant has been connected according to an optimum path.

FIG. 26 is a chart in which Frame A and Frame B and their vicinity have been enlarged.

FIG. 27 is a chart showing how a formant with an intensity of 0, intended for another formant which is in a frame and has no counterpart to be connected, is located in the corresponding frame.

FIGS. 28A and 28B are diagrams illustrating the configurations of formant filters.

FIG. 29 is a table for illustrating a modification method of the cascade connection configuration of formant filters.

FIG. 30 is a chart illustrating the flow of a modification process of the cascade connection configuration of formant filters.

### DESCRIPTION OF THE PREFERRED EMBODIMENTS

A speech analysis and synthesis method based on an ARX (autoregressive-exogenous) speech production model will be summarized.

[ARX Speech Production Model]

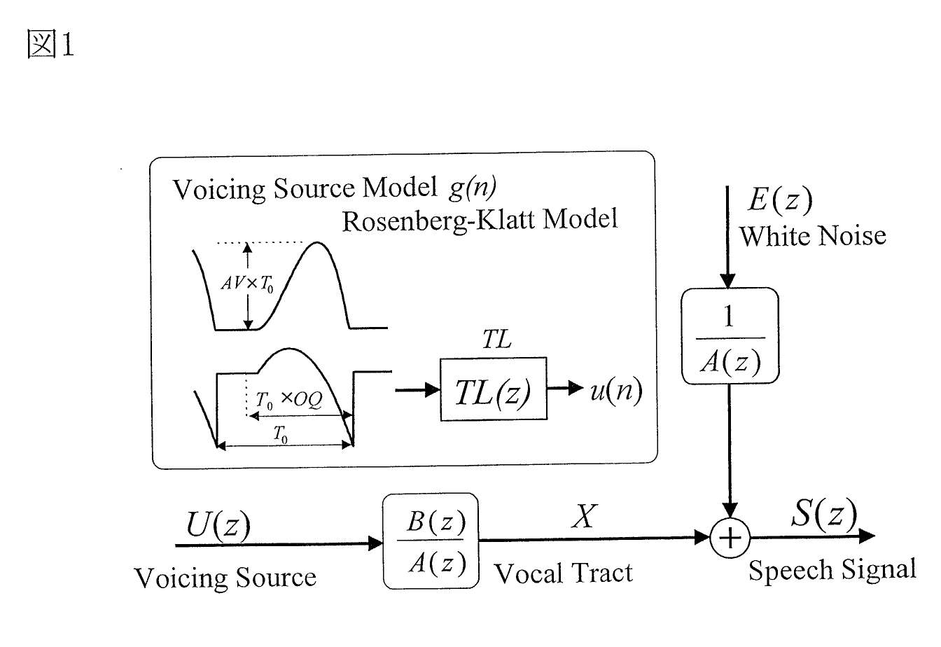

The ARX speech production model is shown in FIG. 1 and represented by a linear difference equation as

$$y ( n ) + {\sum }_{k = 1}^{p} {a}_{k} y ( n - k ) = {\sum }_{k = 0}^{q} {b}_{k} u ( n - k ) + e ( n ) \qquad ( 1 )$$

where the input u(n) denotes a periodic voicing source waveform and the output y(n) a speech signal. A glottal noise component is simulated by white noise e(n) . In the equation, aᵢ and bᵢ are vocal tract filter coefficients, and p and q are ARX model orders. We define A(z) and B(z) as

A(z)=1+a₁z⁻¹+ . . . +aₚz^{-p}

B(z)=b₀+b₁z⁻¹+ . . . b_{q}z^{-q}

Then the z-transform of Equation (1) can be written as

$$Y ( z ) = \frac{B ( z )}{A ( z )} U ( z ) + \frac{1}{A ( z )} E ( z ) \qquad ( 2 )$$

where Y(z), U(z) and E(z) are the z-transforms of y(n), u(n) and e(n), respectively. The vocal tract transfer function is given by B(z)/A(z).

We employ the RK (Rosenberg-Klatt) model (Klatt, D. and Klatt, L., “Analysis synthesis and perception of voice quality variations among female and male talkers.”, J. Acoust. Soc. Amer. Vol. 87, 820-857, 1990) for representing a differentiated glottal flow waveform, including radiation characteristics. The RK waveform is represented by

rk(n)=rk_{c}(nTₛ) (3)

$${rk}_{c} ( t ) = \{ \begin{matrix}2 at - 3 {bt}^{2} , & 0 \leq t < OQT0 \\ 0 , & elsewhere\end{matrix} \\ a = \frac{27 AV}{4 {OQ}^{2} T0} , b = \frac{27 AV}{4 {OQ}^{3} {T0}^{2}} \qquad ( 4 )$$

where Tₛ is a sampling period, AV an amplitude parameter, T0 a pitch period and OQ an open quotient of the glottal open phase of the pitch period. The differentiated glottal flow waveform u(n) is generated by smoothing rk(n) with a low-pass filter where the tilt of the spectral envelope is adjusted by a spectral tilt parameter TL. The low-pass filter is defined as

TL(Z)=(1−cz⁻¹)⁻² (5)

and the low-pass filter coefficient c is related to the tilt parameter TL by

$$TL = 20 {log}_{10} \vert TL ( {ⅇ}^{j 0} ) \vert - 20 {log}_{10} \vert TL ( {ⅇ}^{j {ω}_{0}} ) \vert , \\ c = \frac{B - cos {ω}_{0} - \sqrt{{( B - cos {ω}_{0} )}^{2} - {( B - 1 )}^{2}}}{B - 1} \qquad ( 6 )$$

where B=10^{TL/20}, ω₀=2π3000/Fₛ.

[Analysis Algolitym]

[Estimating Filter Coefficients]

Although Ding et al. employs the Kalman filter algorithm to estimate point-by-point time-variant coefficients of the ARX model taking articulatory movement into account, only a single set of coefficients within a pitch period has to be saved in most applications. The set of coefficients are obtained by averaging all the formant values having a bandwidth below 2,000 Hz. However, the average coefficients are not likely to be appropriate when the formant with broad bandwidth is excluded in the calculation. We use a simple LS (least square) method instead to estimate the averaged coefficients over the analysis frame.

By defining φ and θ as

φ(n)=[−y(n−1) . . . −y(n−p)u(n) . . . u(n−q)]^{T},

θ=[a₁ . . . aₚb₀ . . . b_{q}]^{T}

Equation (1) can be written as

y(n)=φ^{T}(n)θ+e(n), n=1, . . . , N (7)

The prediction error becomes

ε(n,θ)=y(n)−φ^{T}(n)θ (8)

and the least-squares criterion function is

$$V ( θ ) = \frac{1}{N} {\sum }_{n = 1}^{N} \frac{1}{2} {ϵ}^{2} ( n , θ ) \qquad ( 9 )$$

The least-squares estimates are given by

$$\begin{matrix}\hat{θ} = {arg min}_{θ} V ( θ ) \\ = {[ \frac{1}{N} {\sum }_{n = 1}^{N} ϕ ( n ) {ϕ}^{T} ( n ) ]}^{- 1} \frac{1}{N} {\sum }_{n = 1}^{N} ϕ ( n ) y ( n )\end{matrix} \qquad ( 10 )$$

[Compensating Spectral Tilt]

Roots of A(z) and B(z) on the real axis and of very broad bandwidth must be excluded since they are not associated with the vocal tract resonance. Simple exclusion of the roots, however, alters the spectral tilt of the vocal tract transfer function. We introduce a system transfer function D(z) to compensate for the spectrum tilt of

$$C ( z ) = \frac{B ( z ) {A}^{′} ( z )}{A ( z ) {B}^{′} ( z )} \qquad ( 11 )$$

where B′(z)/A′(z) consists of formants that are not excluded. For approximating the spectrum tilt of C(z), we define D(z) of a second-order pole or zero on the real axis,

D(z)=(1−dz⁻¹)^{sgn(TL)2} (12)

where sgn(·) represents the sign of the value. Spectrum tilt parameter TI is given by

TI=20log₁₀|C(e^{j0})|−20log₁₀|C(e^{jω}^{₀})|

where ω₀=2π3000/Fₛ. The coefficient d in Equation (12) is derived from TL in the same way as Equation (6).

[Generating Voice Source]

We generate a multiple pulse source signal of an arbitrary length, for obtaining more stable estimates of the formants. The multiple pulse source signal v(n) is given by

$$v ( n ) = {\sum }_{i = 1}^{M} rk ( n - OQT0 {F}_{s} + GCI ( i ) , AV ( i ) , T0 , OQ ) \qquad ( 13 )$$

T0 is an averaged value of the pitch periods in the analysis frame. The initial value of OQ is set at an appropriate value. Voicing amplitude parameter AV(i) and glottal closure instant GCI(i) are obtained from excitation peaks of inverse filtered speech v′(n), whose z-transform is given as

$${V}^{′} ( z ) = {( \frac{{A}^{′} ( 1 )}{{B}^{′} ( 1 ) D ( 1 ) TL ( 1 )} )}^{- 1} \frac{{A}^{′} ( z )}{{B}^{′} ( z ) D ( z ) TL ( z )} Y ( z ) \qquad ( 14 )$$

The excitation amplitude AE of v′(n) is converted to the AV parameter

$$AV = \frac{4}{27} OQ \cdot AE \qquad ( 15 )$$

[Adaptive Prefilter]

Equation (9) can be expressed in the frequency domain using Parseval's relationship as follows (Ljung, L., “System identification theory for the user.” PRENTICE HALL PTR, 201-202, 1995)

$$\begin{matrix}V ( θ ) ≅ \frac{1}{2 N} {\sum }_{k = 0}^{N - 1} \{ {\vert G ( {ⅇ}^{j 2 π k / N} ) - \frac{B ( {ⅇ}^{j \frac{2 π}{N} k} , θ )}{A ( {ⅇ}^{j \frac{2 π}{N} k} , θ )} \vert}^{2} {\vert W ( \frac{2 π}{N} k , θ ) \vert}^{2} \} \\ where & ( 16 ) \\ G ( {ⅇ}^{j 2 π k / N} ) = \frac{Y ( \frac{2 π}{N} k )}{U ( \frac{2 π}{N} k )} , \\ Y ( \frac{2 π}{N} k ) = \frac{1}{\sqrt{N}} {\sum }_{n = 1}^{N} y ( n ) {ⅇ}^{- j 2 π k / N} , \\ U ( \frac{2 π}{N} k ) = \frac{1}{\sqrt{N}} {\sum }_{n = 1}^{N} u ( n ) {ⅇ}^{- j 2 π k / N} , \\ W ( ω , θ ) = U ( ω ) A ( {ⅇ}^{j ω} , θ ) & ( 17 )\end{matrix}$$

From Equation (16), the prediction-error method can be interpreted as a method of fitting the model vocal transfer function to the empirical transfer-function estimate (ETFE) G(e^{j2πk/N}) with weighting function W(ω,θ).

If the input signal and the output signal of the system is prefiltered with L(z)

L(z)=1+l₁z⁻¹+l₂z⁻² . . . +lᵣz^{-r} (18)

the weighting function can be rewritten as

W(ω,θ)=U(ω)A(e^{jωl , θ)}L(e^{jω}) (19)

which implies that W(ω,θ) can be controlled by a prefilter L(z). In the ARX speech production model, the spectral tilt of the voicing source U(ω) is determined by TL , and the spectral tilt of A(e^{jω}) is assumed to be flat in a wide frequency range although A(e^{jω}) has anti-resonance in a local frequency range. Ding et al. ignored the effects of the spectral tilt parameter TL and used an invariant filter L(z), such as L(z)=1−z⁻¹.

We employ an adaptive prefilter L(z) taking into account the effects of TL in order to cancel out U(ω) in weighting function W(ω). The coefficients of prefilter L(z) are obtained form the next AR model using the LS method,

$$u ( n ) = {\sum }_{k = 1}^{r} {l}_{k} u ( n - k ) + ξ ( n ) \qquad ( 20 )$$

where the model order is r, typically 6 or 8, and ξ(n) is white noise.

[Estimating Open Quotient]

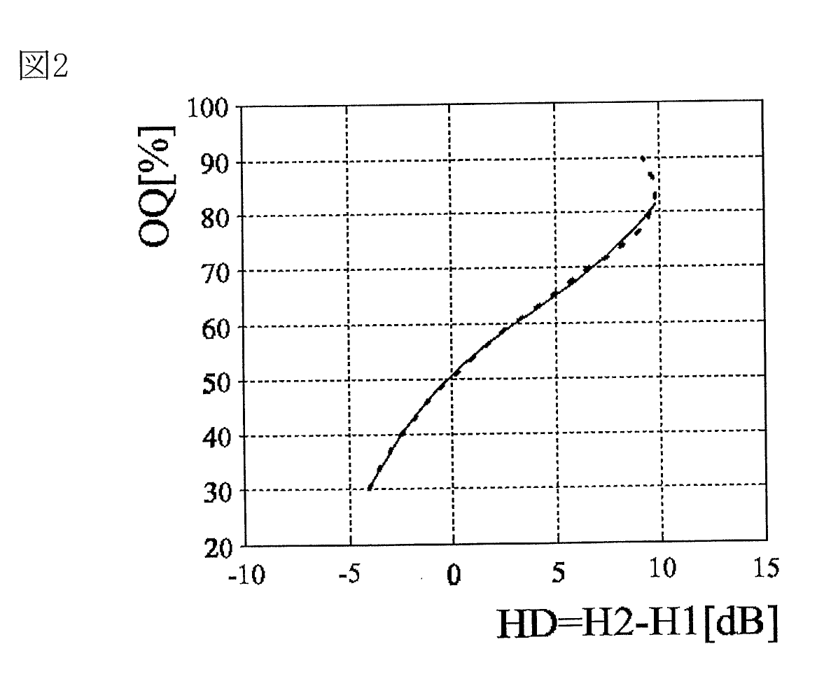

Open quotient OQ of the RK model is primarily related to the first harmonic level(H1) and the second harmonic level(H2) of the multi pulse source, as shown in FIG. 2. OQ [%] is given by the following equation,

$$\begin{matrix}OQ = 3.65 HD - 0.273 {HD}^{2} + 0.0224 {HD}^{3} + 50.7 , \\ - 4.03 \leq HD \leq 9.83\end{matrix} \qquad ( 21 )$$

where HD=H2−H1[dB], and H2 and H1 are obtained from the DFT of inverse filtered speech, given by Equation (14).

[Synthesis Algorithm]

A cascade formant synthesizer is used to synthesize both voiced and unvoiced speech. The RK model is used to synthesize voiced speech, where as the M-sequence, pseudo random binary signal, is used to synthesize unvoiced speech.

[Voicing Source Control]

We apply two all pass filters (APF)(Kawahara, H., “Speech representation and transformation using adaptive interpolation of weighted spectrum: vocoder revisited”, ICASSP 97, 1303-1306, 1997) to the RK voicing source in order to solve two problems:

Since the interval between two successive glottal closure instants (GCIs) can be considered as the cue of human cognition of F0, we have to carefully control the position of the RK waveform.

Since a constant sequence of the voicing source wave form causes buzzy sound quality, certain fluctuations must be introduced into the source waveform.

An improved voicing source rk′(n) follows the next equation.

$${rk}^{′} ( n ) = \frac{1}{\sqrt{N}} {\sum }_{k = - N / 2 + 1}^{N / 2} {R}^{′} ( \frac{2 π}{N} k ) {ⅇ}^{j 2 π k / N} \\ {R}^{′} ( \frac{2 π}{N} k ) = R ( \frac{2 π}{N} k ) {ⅇ}^{j ( {Θ}_{s} ( k ) - {Θ}_{r} ( k ) )} \qquad ( 22 )$$

where R(2πk/N) is the DFT of Equation (3),

$$R ( \frac{2 π}{N} k ) = \frac{1}{\sqrt{N}} {\sum }_{n = 0}^{N - 1} rk ( n ) {ⅇ}^{- j 2 π k / N} \qquad ( 23 )$$

Phase Θₛ(k) shifts by T_{d}[sec] the voicing source waveform,

$${Θ}_{s} ( k ) = \frac{2 π}{N} \frac{{T}_{d}}{{F}_{s}} k \qquad ( 24 )$$

Θᵣ(k), on the other hand, randomizes the group delay in the higher frequency range,

$${Θ}_{r} ( k ) = \{ \begin{matrix}{η}^{′} ( k ) , & k = 0 , … , \frac{N}{2} \\ - {η}^{′} ( - k ) , & k = - \frac{N}{2} + 1 , … , - 1\end{matrix} \\ {η}^{′} ( k ) = \frac{2 π}{N} {\sum }_{l = 0}^{k} {w}_{η} ( l ) η ( l ) \\ {w}_{η} ( l ) = \frac{1}{1 + {ⅇ}^{( {w}_{c} - 2 π l / N ) / {w}_{t}}} \\ η ( l ) \sim N ( 0 , {d}_{g} {F}_{s} ) , l = 0 , … , \frac{N}{2} \qquad ( 25 )$$

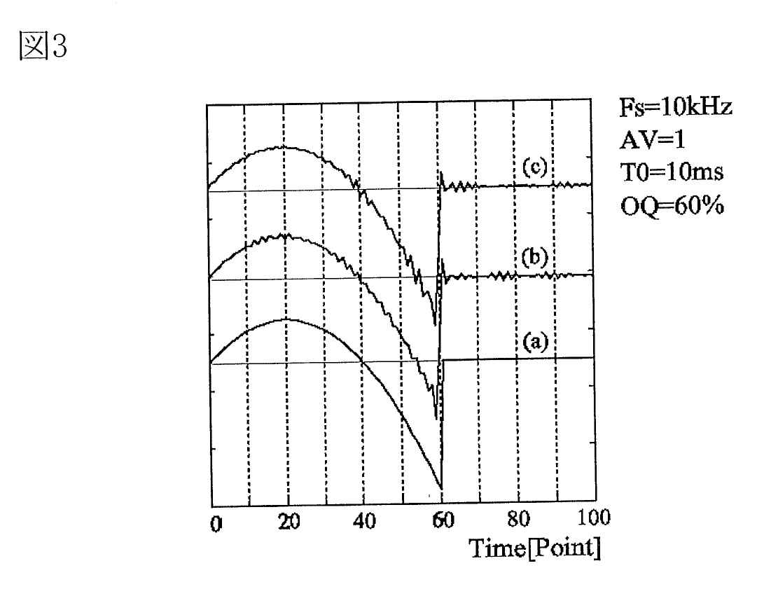

The group delay η(l) is white noise with zero mean and variance d_{g}Fₛ[point]. Weighting window w_{η}(l) is used to manipulate phase in high frequency defined by a cutoff frequency ω_{c}[rad] (typically, 2π100/Fₛ). An example is shown in FIG. 3.

[Optimum Formant Connection]

The automatic estimation described above does not always guarantee that the coefficients of the vocal tract transfer function will vary continuously. In the formant synthesizer which is a time-variant system, discontinuity of the digital filter coefficients causes click sounds. Discontinuity will occur in two cases, 1) if the number of formants between two successive frames is not the same, 2)if a formant frequency changes abruptly.

Dynamic programming is applied to attain an optimum match between the formants F(n) and F(n+1) with a distance measure consisting of connection cost d_{c}(F(n),F(n+1)) and disconnection cost d_{d}(F(k)).

d_{c}(F(n),F(n+1))=α|F_{f}(n)−F_{f}(n+1)|+β|Fᵢ(n)−Fᵢ(n+1)| (26)

$$\begin{matrix}{d}_{d} ( F ( k ) ) = α \vert {F}_{f} ( k ) - {F}_{f} ( k ) \vert + β \vert {F}_{i} ( k ) - ϵ \vert \\ = β \vert {F}_{i} ( k ) - ϵ \vert\end{matrix} \qquad ( 27 )$$

where F_{f} is the formant frequency and Fᵢ is the formant intensity. The formant intensity Fᵢ is defined as the difference between the maximum and minimum levels of the spectrum of the formant.

$${F}_{i} ( n ) = \{ \begin{matrix}20 {log}_{10} ( \frac{1 + {ⅇ}^{- π {F}_{b} ( n ) / {F}_{s}}}{1 - {ⅇ}^{- π {F}_{b} ( n ) / {F}_{s}}} ) , if formant \\ 20 {log}_{10} ( \frac{1 - {ⅇ}^{- π {F}_{b} ( n ) / {F}_{s}}}{1 + {ⅇ}^{- π {F}_{b} ( n ) / {F}_{s}}} ) , if anti \text{-} formant\end{matrix} \qquad ( 28 )$$

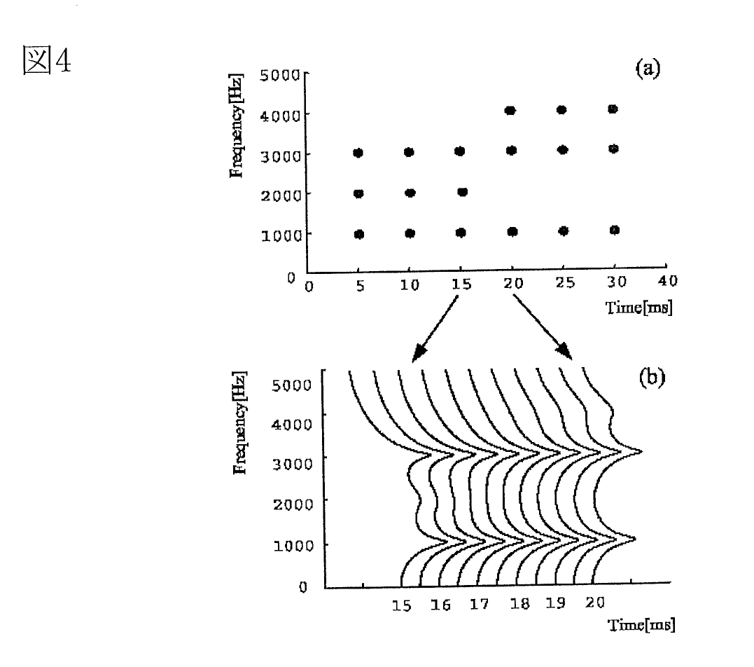

When the formant does not have a counterpart, a formant with the same frequency and an intensity of a small value ε is regarded as the formant to be connected. The results of a simulation of optimum formant connections show that spectral envelopes vary smoothly even if the formant frequency varies rapidly, as seen in FIG. 4.

[Experiments]

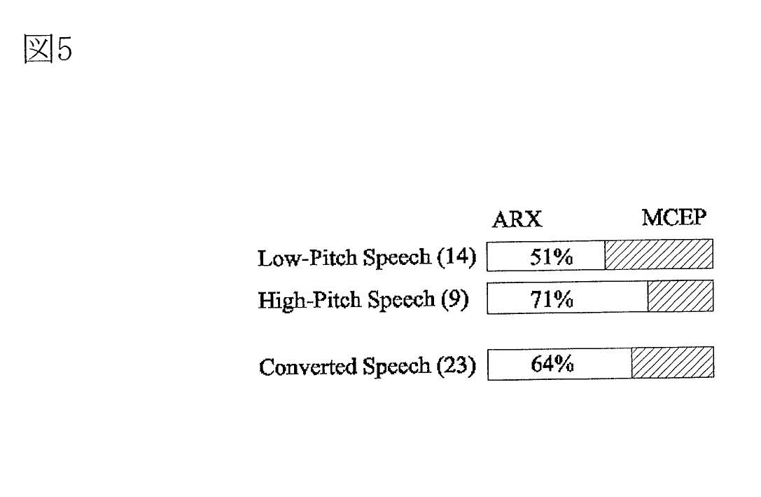

A long Japanese sentence read by 18 males and 5 females was subjected to analysis-synthesis experiments. The 18 talkers were selected from a speech data corpus of 108 males that were prepared for research on voice quality variations associated with talker individuality and were regarded as representing enough of the original 108 males in terms of voice quality variations (Ljung, L, “System Identification theory for the user.” PRENTICE HALL PTR, 201-202, 1995). After confirming the superiority of the proposed method to the one by Ding et al. in synthetic sound quality, a further comparison was made between a well-known mel cepstral (MCEP) method (Tokuda, K., Matsumura, H., and Kobayashi, T.“Speech coding based on adaptive mel-cepstral analysis.” ICASSP 94, 197-200, 1994) and our ARX method. The same speech samples as in the previous experiment were used. The sampling frequency for digitization was 11.025 kHz. In order to test robustness against pitch conversion, speech samples were also re-synthesized which have the higher fundamental frequency than the original by 1.5 times. A paired comparison test was made by five subjects who were asked to choose more naturally sounding synthetic stimulus. Results are illustrated in FIG. 5, where statistics are made for the two pitch groups, low and high pitch, and pitch conversion. Although the difference is small for the low pitch speech data-between the ARX and MCEP methods, it is clear that the ARX method works much better for high pitch voices.

Embodiment 1

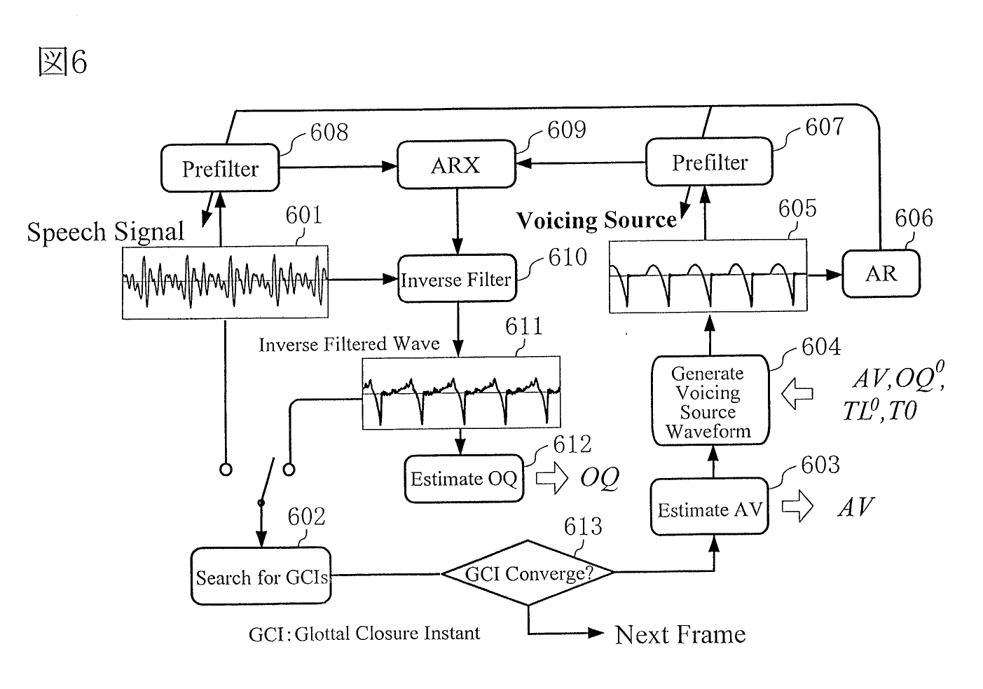

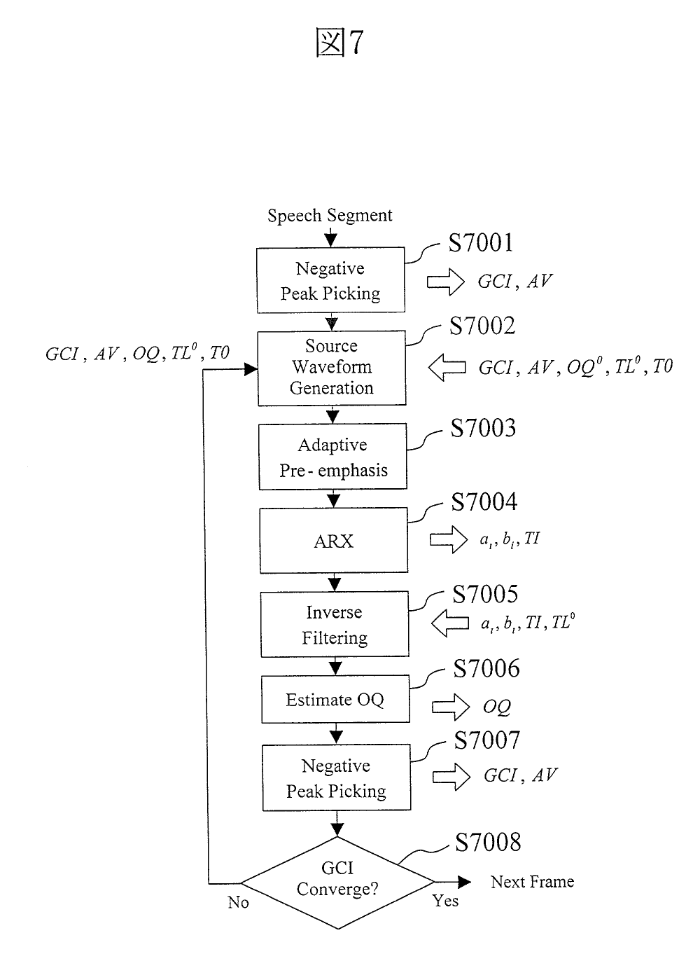

FIG. 6 is a block diagram illustrating the configuration of a speech analysis system according to a first embodiment of the present invention. This system operates in accordance with the flow shown in FIG. 7. Hereinafter, how the system operates will be described with reference to FIGS. 6 and 7.

A speech segment 601 is cut out from a speech waveform to be analyzed using a window function with a window length of about 25-35 msec. The well-known Hanning window or the like is used as the window function. Such a window length of 25-35 msec is considerably long, compared to those used in conventional analysis methods, and corresponds to almost the same as the total length of several pitch periods together cut out from a speech waveform having a normal pitch range for a male or female speech.

<Step S7001>

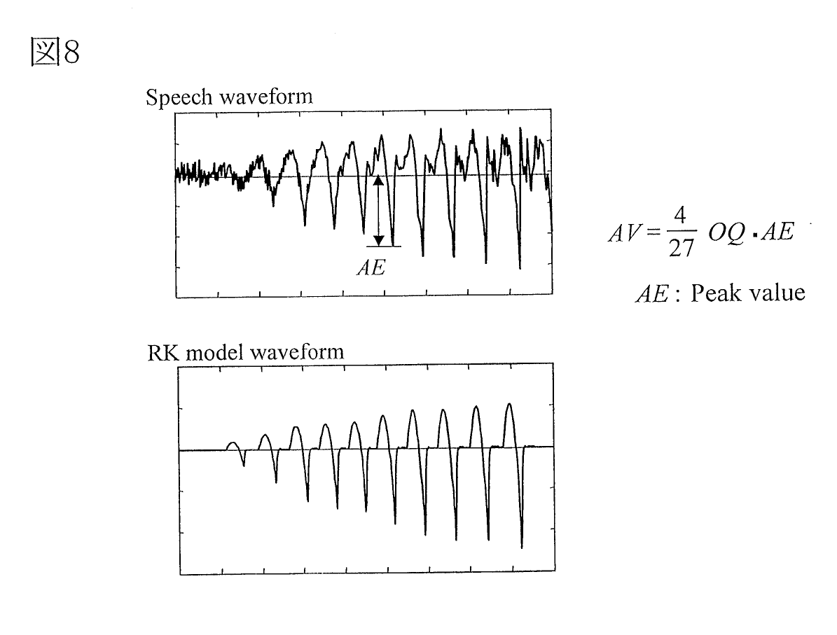

Next, in a GCI searching unit 602 and an AV estimation unit 603, peak picking in a negative direction is performed to obtain GCIs (glottal closure instances) and an initial value for AV from the speech segment 601. As for GCIs, peak positions of the speech segment 601 in a negative direction are used. AV is obtained using Equation (15) and as shown in FIG. 8 so that the peak values of the speech segment 601 correspond to peaks of an RK voicing source in a negative direction.

<Step S7002>

Next, in a voicing source waveform generating unit 604, an RK model waveform shown in FIG. 1 and Equation (3) is generated so that its negative peak positions are synchronized with the GCIs, thereby generating a voicing source waveform 605. In this case, used as parameters for the RK model are the value obtained in Step S7001 for AV, 0.6 for OQ⁰ which is the initial value of OQ, and an appropriate value selected from between 5 and 15 for TL⁰. T0 is an average pitch period in a frame to be analyzed. The voicing source waveform generating unit 604 generates the voicing source 605 according to Equation (13).

<Step S7003>

Next, in an AR analysis unit 606, the voicing source waveform 605 which has been generated by the voicing source waveform generating unit 604 is AR analyzed. Use is made of 6 or 8 for the model order of the AR analysis. Adaptive pre-emphasis is performed on the voicing source wave form 605 and the speech segment 601 by adaptive pre-emphasis filters 607 and 608 with the filter coefficients which have been obtained by the AR analysis. The adaptive pre-emphasis filters 607 and 608 can be represented by Equation (18).

<Step S7004>

Next, in an ARX analysis unit 609, ARX analysis is conducted using the voicing source waveform 605 and the speech segment 601 which have been adaptively pre-emphasized by the adaptive pre-emphasis filters 607 and 608 in the manner shown in Equations (7) through (10). As a result, an AR coefficient aᵢ and an MA coefficient bᵢ are obtained from Equation (10) and thereby A(z) and B(z) in Equation (2) are determined. Then, by solving the below equations where A(z)=0 and B(z)=0, a formant frequency F_{f}(n), a formant band-width F_{b}(n), an anti-formant frequency AF_{f}(n), and an anti-formant band-width AF_{b}(n) are obtained. That is to say, if the complex number solution of A(z)=0 is represented by r₁, . . . rₚ, and the complex number solution of B(z)=0 is represented by s₁, . . . , S_{q}, F_{f}(n) , F_{b}(n), AF_{f}(n), and AF_{b} (n) can be obtained from the following equations:

$$F ( k ) = \vert \frac{arg {r}_{k}}{2 π {T}_{s}} \vert , B ( k ) = \vert \frac{ln \vert {r}_{k} \vert}{π {T}_{s}} \vert$$

$$AF ( l ) = \vert \frac{arg {s}_{l}}{2 π {T}_{s}} \vert , AB ( l ) = \vert \frac{ln \vert {s}_{l} \vert}{π {T}_{s}} \vert$$

where the following equations are given.

$$arg c = arctan \frac{Im ( c )}{Re ( c )}$$

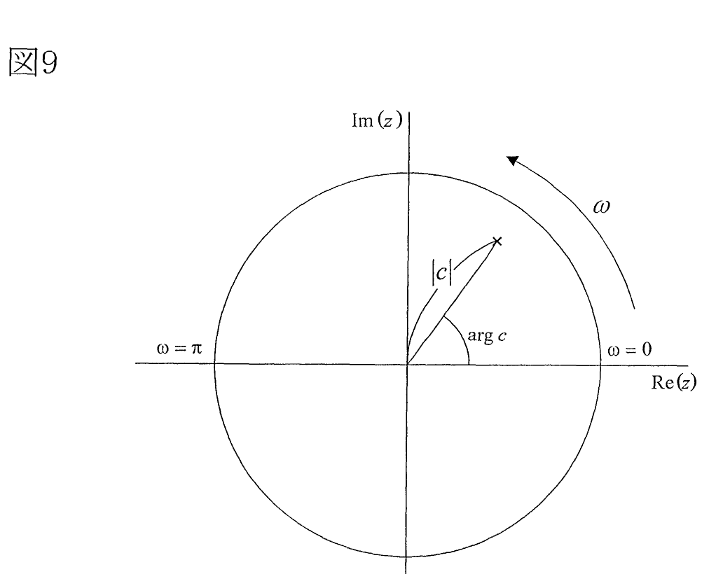

These equations express the complex number c by polar coordinates, as shown in FIG. 9.

Note that the formant with a broad bandwidth is excluded here. The formant exclusion results in effects on an estimated spectral tilt, and thus TI is estimated in the manner shown in Equations (11) through (12).

<Step S7005>

Next, an inverse filter 610shown in Equation (14) is constructed using the formant parameters F_{f}(n), F_{b}(n), the spectral tilt TI, and the voicing source spectral tilt TL⁰, which have been estimated, and then a voicing source waveform 611 is estimated from the speech segment 601.

<Step S7006>

Next, in an OQ estimation unit 612, OQ is estimated. Specifically, HD=H2−H1, which is the difference between the first harmonic level H1 and the second harmonic level H2, is obtained from DFT (discrete Fourier transform) of the voicing source waveform 611 which has been estimated by the inverse filter 610, and thereby OQ is estimated using Equation (21).

<Step S7007>

Next, in the GCI searching unit 602 and the AV estimation unit 603, peak picking in a negative direction is performed on the voicing source waveform 611 having been estimated by the inverse filter 610 and thereby GCIs and a value for AV are obtained from the voicing source waveform 611. GCIs and AV are obtained in the same manner as described in Step S7001.

<Step 7008>

Next, in a determination unit 613, it is determined whether GCIs converge to a predetermined value. If GCIs do not converge, the process will repeat estimation from Step S7002. If GCIs converge, the process completes the analysis of the current frame and will proceed with the analysis of the next frame. Note that the period of a frame is preferably 5-10 ms.

As has been described, in the speech analysis system according to the first embodiment, voicing source parameters and a glottal transfer function can be estimated with high accuracy from a female speech of a high pitch frequency or the like, by setting the analysis window length at about 25-35 msec, which is longer than that in a conventional system and then estimating voicing source positions of multiple pitch frequencies at a time, or the like.

Embodiment 2

In the first embodiment, GCI estimation by peak picking in Steps S7001 and S7007 is performed for each sample. In a second embodiment of the present invention, GCI estimation is carried out with higher accuracy at closer intervals than that with a sampling period and an RK voicing source wave form highly accurately synchronized with GCIs is generated in Step S7002, resulting in improved analysis accuracy.

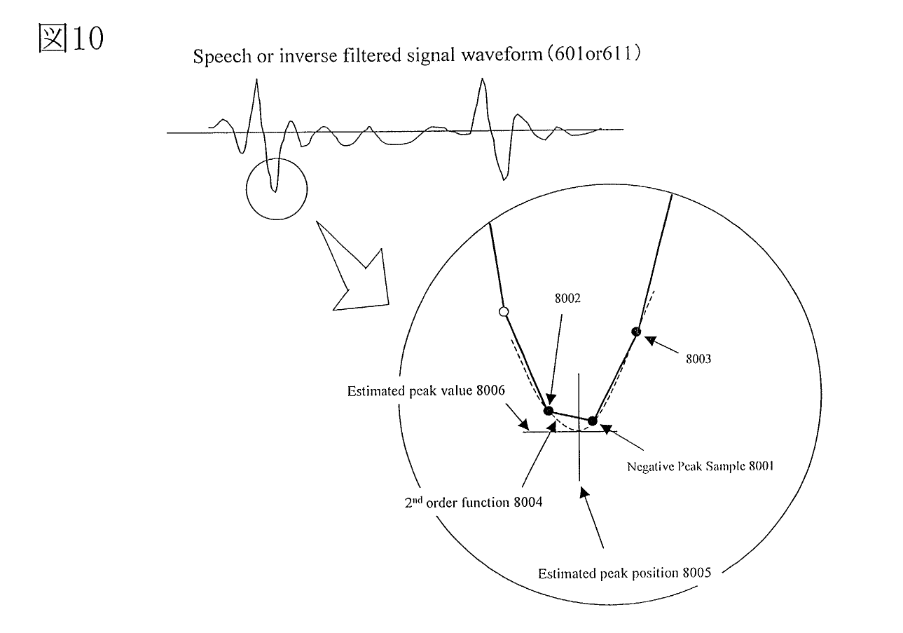

A method for highly accurate GCI estimation is shown in FIG. 10. Negative peak positions of the speech segment 601 or the voicing source wave form 611 which has been estimated by the inverse filter 610 are accurately obtained by secondary interpolation. Specifically, a peak 8001 is detected for each sample, a quadratic function 8004 is obtained whose graph contains three points of the peak 8001, its previous sample 8002 and its subsequent sample 8003, and a peak position 8005 and a peak value 8006 of the quadratic function 8004 are then obtained.

The peak position 8005, which has been obtained in this manner, is a GCI, but a value for the GCI is represented not by a sampling position of integral but by a real number. In order to adjust negative peak positions of the RK voicing source model to CGI positions represented by real numbers, the RK voicing source model is time-shifted using all pass filters. In other words, the RK voicing source model which corresponds to a pitch period is shifted according to Equations (22) through (24). Note that Θᵣ(k)=0 is applied here. T_{d} in Equation (24) may be replaced with a time difference between the estimated peak position 8005 and the sample position 8002 located right before the peak position 8005 which are shown in FIG. 10.

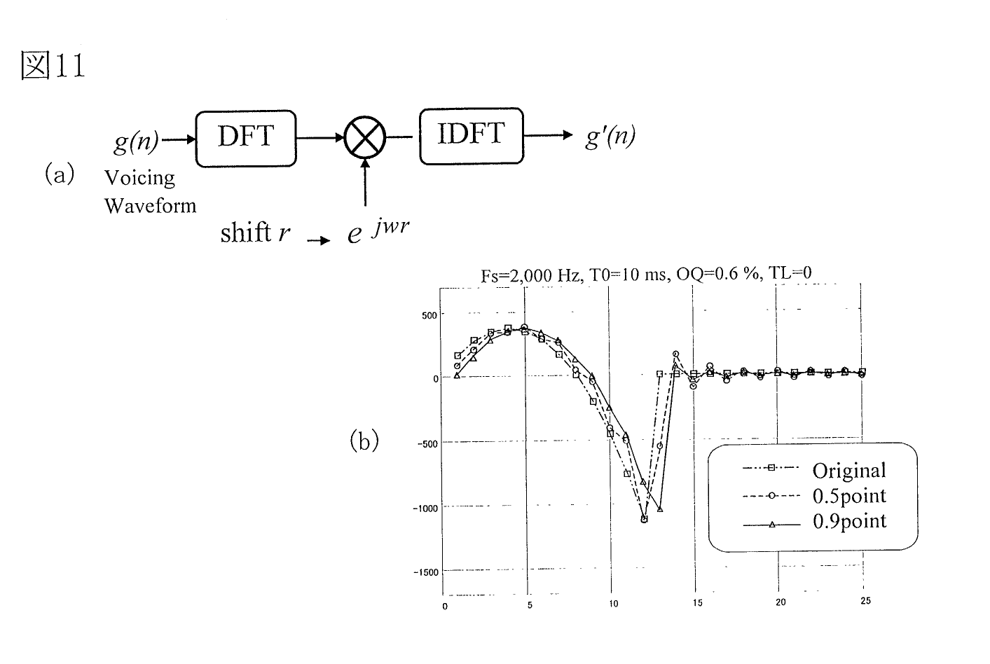

FIG. 11A shows an exemplary RK voicing source waveform being shifted with higher accuracy at closer time intervals than that with the sampling period by means of the all pass filters. In the graph shown in FIG. 11B, an original RK voicing source waveform, a 0.5 point-shifted RK voicing source waveform, and a 0.9 point-shifted RK voicing source waveform are represented in overlapping relation. In this manner, by synchronizing negative peak positions of the RK model waveform with GCIs with higher accuracy at closer time intervals than that with the sampling period, the analysis accuracy can be improved.

As has been described above, in the speech analysis system according to the second embodiment, in estimating of voicing source positions, negative peak positions of a speech segment or a voicing source waveform having been estimated by an inverse filter are accurately obtained by secondary interpolation, and then the RK voicing source model is time-shifted by all pass filters so that its negative peak positions are adjusted to the negative peak position of the speech segment or the voicing source waveform. This allows a highly accurate estimation of GCIs, resulting in increased accuracy in estimating of voicing source parameters and a vocal tract transfer function.

Embodiment 3

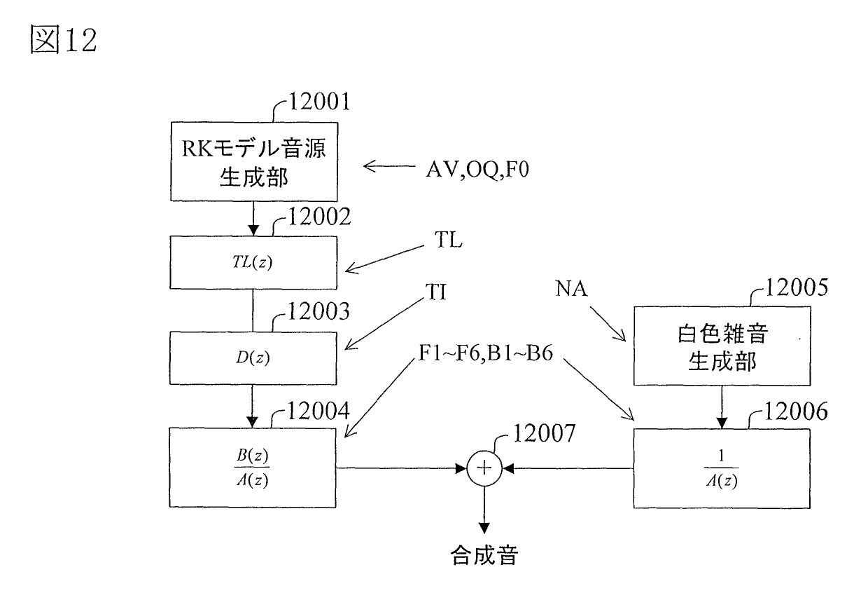

FIG. 12 is a block diagram illustrating the configuration of a speech synthesis system according to a third embodiment of the present invention. The speech synthesis system generates a synthesized speech in accordance with Equation (2), and includes an RK model voicing source generation unit 12001, a voicing source spectral tilt filter (TL(z)) 12002, a vocal tract spectral tilt filter (D(z)) 12003, a vocal tract filter (B(z)/A(z)) 12004, a white noise generation unit 12005, a white noise filter (1/A(z)) 12006 and a mixing unit 12007.

A speech, which has been analyzed by the speech analysis system according to the first or second embodiments of the present invention is represented as the following parameter for each analyzed frame, and then transmitted to the speech synthesis system.

| Types of Parameters | Name | Meaning |
|---|---|---|
| Voicing source | AV | Amplitude of RK voicing |
| parameter | | source model |
| | OQ | Vocal cord opening rate |
| | | of RK voicing source |
| | | model |
| | F0 | Fundamental frequency of |
| | | RK voicing source model |
| | TL | Spectral tilt rate |
| | NA | Amplitude of white noise |
| Spectral tilt | TI | Spectral tilt |
| compensation rate | | compensation rate |
| filter | | |
| Formant | F1˜F6 | Center frequency of 1^{st} |
| | | through 6^{th} formants |
| | B1˜B6 | Bandwidth of 1^{st} through |
| | | 6^{th} formants |

Here, each of AV, OQ, F0 and TL takes some value other than 0 only in voiced parts and 0 in voiceless parts. On the other hand, NA takes some value other than 0 only in voiceless parts and 0 in voiced parts.

The RK model voicing source generation unit 12001 uses the parameters AV, OQ and F0 to generate a voicing source waveform according to Equation (13). The voicing source spectral tilt filter 12002 uses the parameter TL to modify the spectral tilt of the voicing source waveform from the RK model voicing source generation unit 12001 according to Equation (5). The vocal tract spectral tilt filter 12003 uses the parameter TI to compensate a spectral tilt according to Equation (12). The voicing source waveform whose spectral tilt has been compensated by the vocal tract spectral tilt filter 12003 is supplied to the mixing unit 12007 via the vocal tract filter 12004. Specifically, the voicing source waveform according to the first term of the right side of Equation (2) is supplied to the mixing unit 12007. The white noise generation unit 12005 generates a random noise at a gain dependent on the parameter NA. The random noise generated from the white noise generation unit 12005 is supplied to the mixing unit 12007 via the white noise filter 12006. Specifically, a noise waveform according to the second term of the right side of Equation (2) is supplied to the mixing unit 12007. The mixing unit 12007 synthesizes the voicing source waveform from the vocal tract filter 12004 and the noise waveform from the white noise filter 12006 and thereby generates a synthesized speech signal according to Equation (2).

As has been described above, in the speech synthesis system according to the third embodiment, it is possible to synthesize a speech with high sound quality which sounds very close to the original speech sound by separately synthesizing parameters, which have been estimated by the speech analysis system according to the first and the second embodiments, for each frame.

Embodiment 4

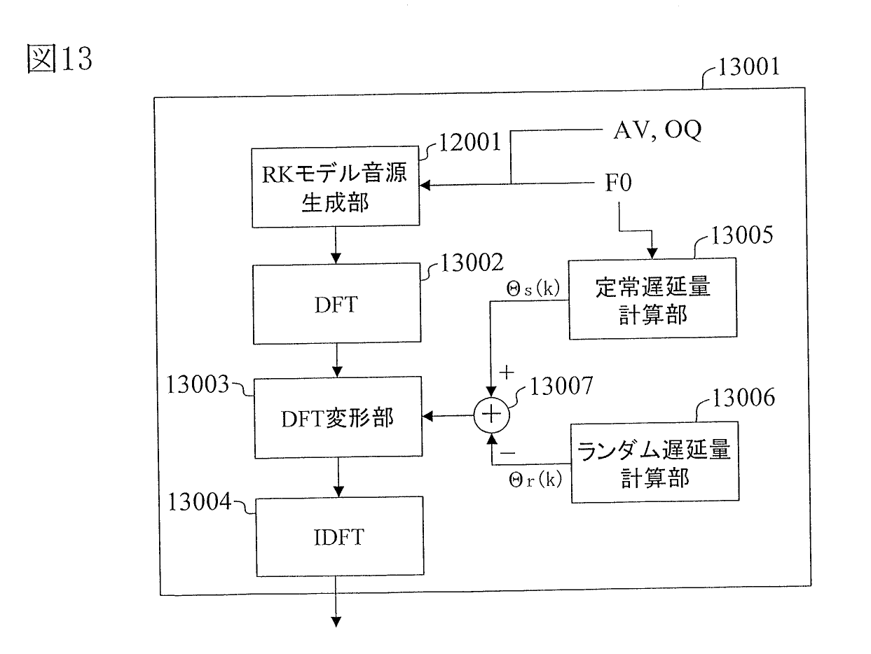

A speech synthesis system according to a fourth embodiment of the present invention includes an RK model voicing source generation unit 13001 shown in FIG. 13 instead of the RK model voicing source generation unit 12001 shown in FIG. 12. Other structures are the same as in the RK model voicing source generation unit shown in FIG. 12. The RK model voicing source generation unit 13001 shown in FIG. 13 includes an RK model voicing source generation unit 12001 ,a DFT (discrete Fourier transformation) calculation unit 13002, a DFT modification unit 13003, an IDFT (inverse discrete Fourier transformation) calculation unit 13004, a stationary delay calculation unit 13005, a random delay calculation unit 13006 and a synthesis unit 13007.

The RK model voicing source generation unit 12001 is equivalent to one shown in FIG. 12. The DFT calculation unit 13002 perform DFT on the voicing source waveform from the RK model voicing source generation unit 12001 into a frequency domain according to Equation (23). The stationary delay calculation unit 13005 uses the parameter F0 to calculate the delay Θₛ(k) according to Equation (24). The random delay calculation unit 13006 calculates the random delay Θᵣ(k) according to Equation (25). The synthesis unit 13007 adds the stationary delay Θₛ(k) to the random delay Θᵣ(k) and then supplies the sum (Θₛ(k)−Θᵣ(k)) to the DFT modification unit 13003. The DFT modification unit 13003 modifies the voicing source waveform, which is now in a frequency domain, from the DFT calculation unit 13002 according to the second equation of Equation (22). The IDFT calculation unit 13004 performs IDFT on the voicing source waveform in the frequency domain, which has been modified by the DFT modification unit 13003, to return the voicing source waveform to a time domain according to the first equation of Equation (22).

By adding a fluctuation to the speech segment in the manner as described above, it is possible to:

1) accurately control glottal closure timing; and

2) prevent buzzy sound quality.

Embodiment 5

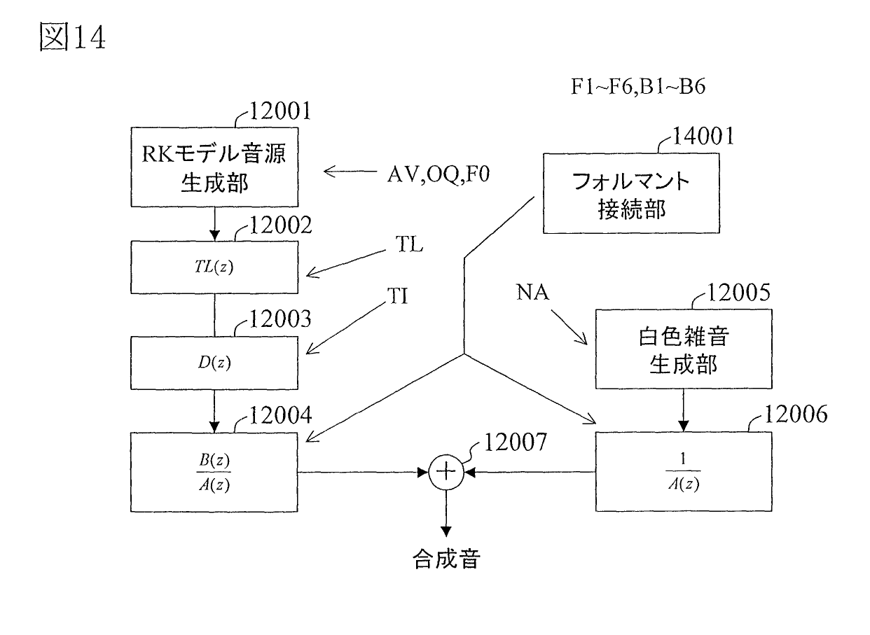

FIG. 14 is a block diagram illustrating the configuration of a speech synthesis system according to a fifth embodiment of the present invention. The speech synthesis system illustrated in FIG. 14 further includes a formant connection unit 14001 in addition to the members of the configuration of the speech synthesis system shown in FIG. 12. The formant connection unit 14001 optimizes formant connections taking into account the continuities for formant parameters F1 through F6 and B1 through B6 between adjacent frames. The formant connection unit 14001 determines the correspondence of formants between the frames by dynamic programming using a connection cost and a disconnection cost shown in Equations (26) and (27).

Hereinafter, the dynamic programming operation will be described in detail.

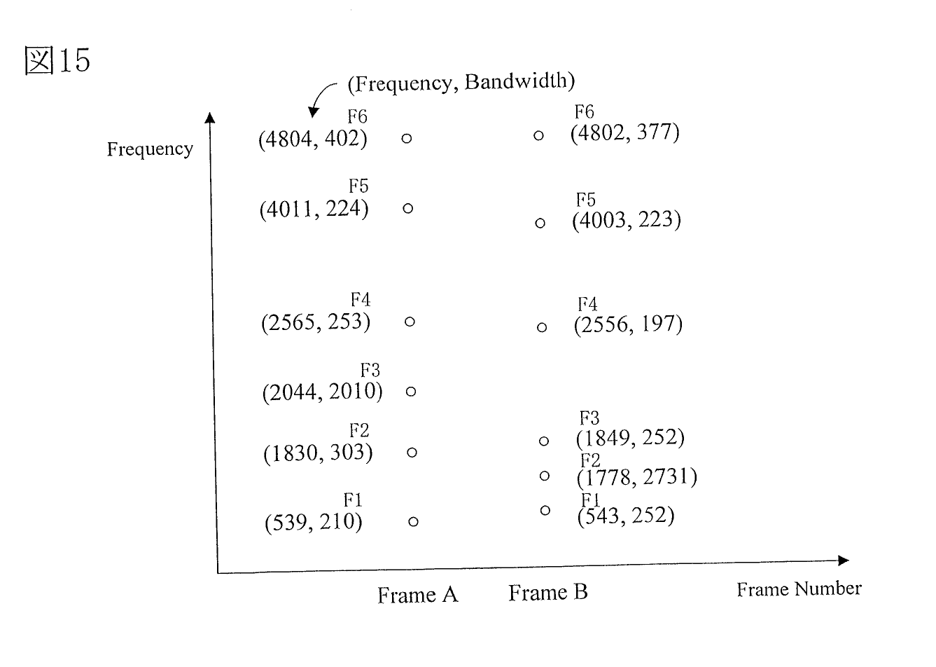

FIG. 15 illustrates the formant frequencies and bandwidths of two adjacent frames. The abscissa indicates frame numbers and the ordinate indicates frequencies. The frequency and the bandwidth of each formant are indicated in values, which are shown as (Frequency, Bandwidth). Two frames (Frame A and Frame B) have six formants each. These formants in each frame are called F1, F2 and the like in the order of increasing frequency. Normally, among these sets of six formants, ones with the same number in Frame A and Frame B are connected each other. However, the frequencies of F2 and F3 in Frame B are close each other, and both are close to the frequency of F2 in Frame A. Also, the bandwidth of F2 in Frame B takes a considerably large value. A formant with a broad bandwidth is low in intensity, and thus the formant is considered as one that is disappearing or appearing. Accordingly, F2 in Frame B is considered as one that is appearing, and it is therefore desirable that F2 in Frame B is not connected with F2 in Frame A. In this case, F2 in Frame A should be connected with F3 in Frame B. Dynamic programming is used for automatically determining this kind of matters.

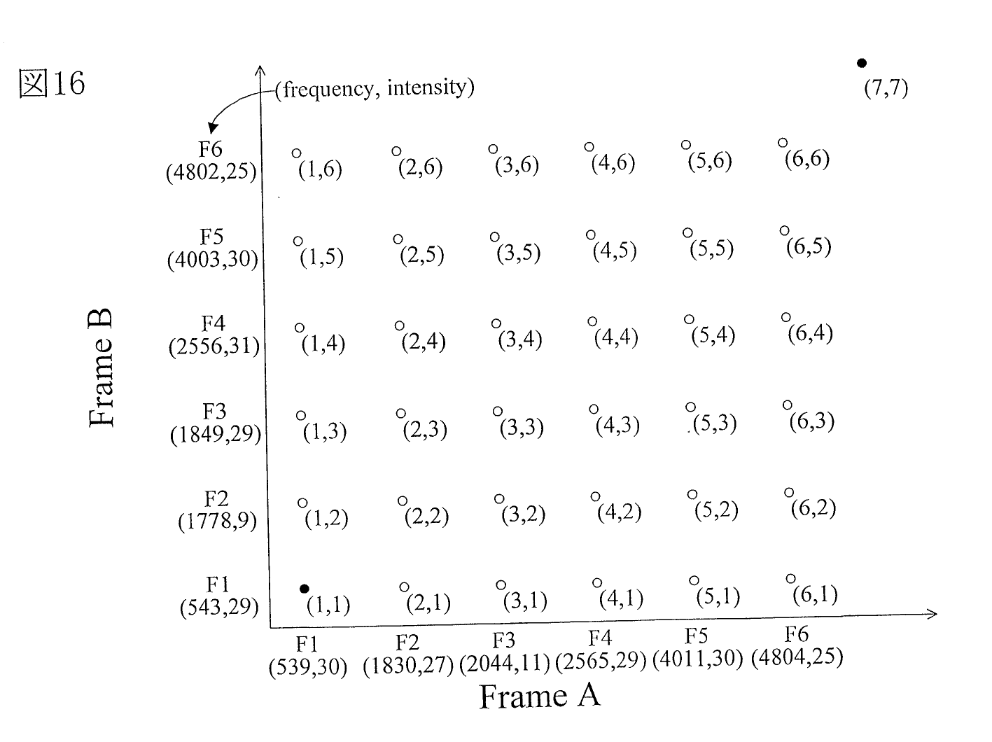

FIG. 16 plotted formants in Frame A as the abscissa and formants in Frame B as the ordinate, and grid points are indicated therein by coordinates (1,1), (1,2) and the like. In the figure, each formant is given its values of frequency and intensity in the form of (frequency, intensity). The intensity of each formant is represented by a value obtained by transforming the bandwidth thereof according to Equation (28).

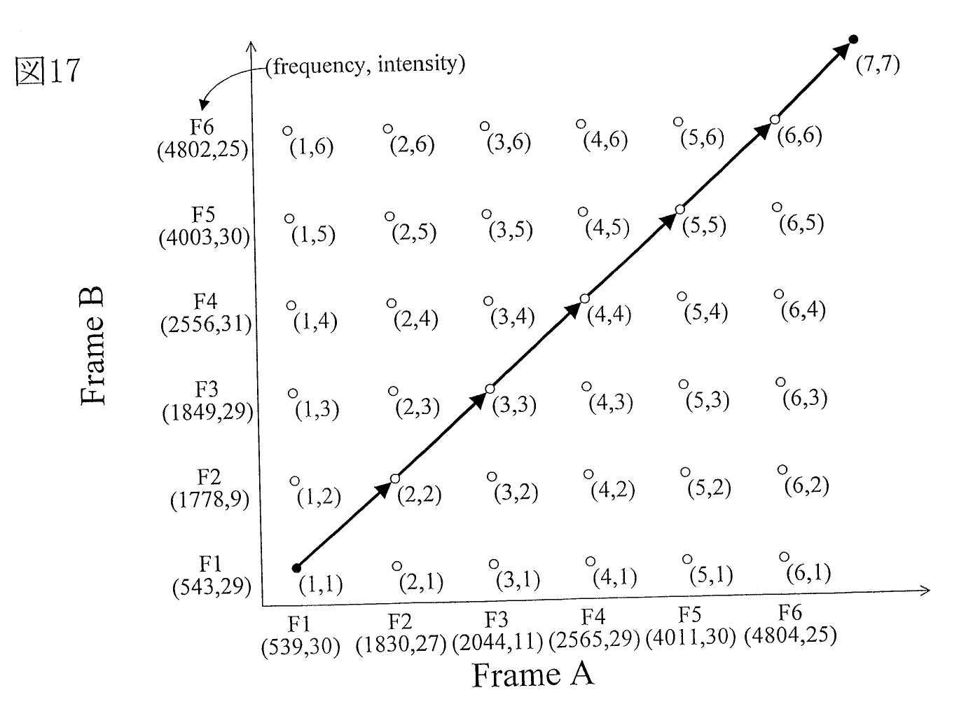

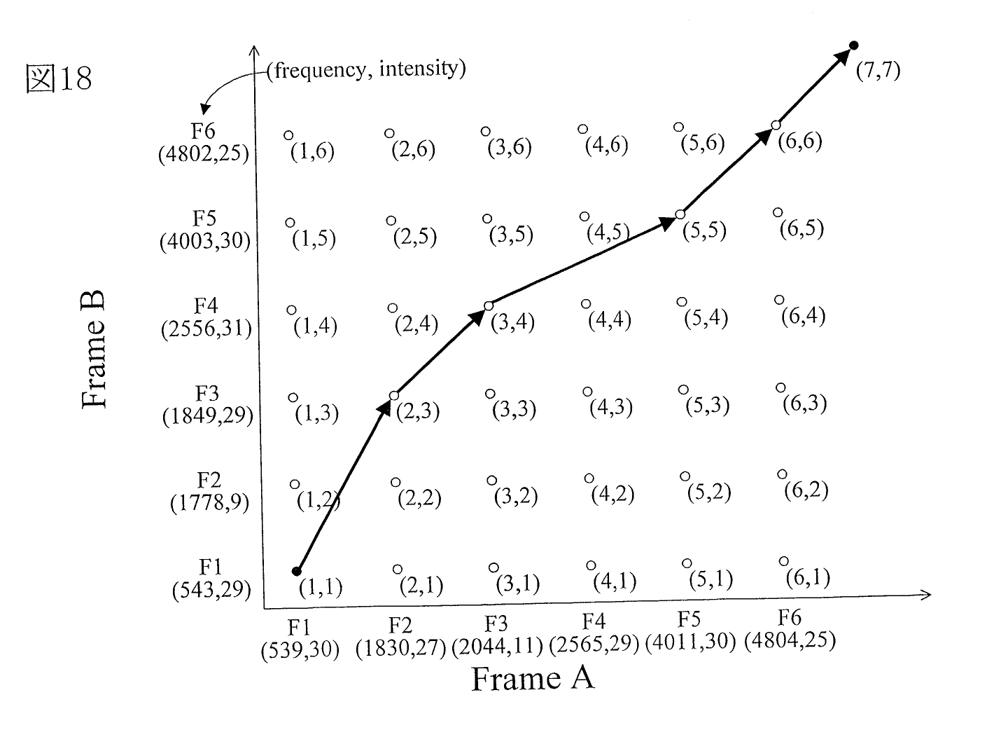

The two frames has six formants each and therefore the number of grid points reaches 36 from (1,1) through (6,6). And, in the figure, an additional point (7,7) is given. Assume that a path extends from (1,1) toward (7,7), passing through grid points. For example, as shown in FIG. 17, a path which passes through points (1,1), (2,2), (3,3), (4,4), (5,5), (6,6) and (7,7) can be drawn. In this case, the point (1,1) corresponds to F1 in Frame A and F1 in Frame B, and the point (2,2) and the subsequent ones likewise. Accordingly, when the path described above is drawn, the six formants from F1 through F6 are all connected with their counterparts with the same number. However, as shown in FIG. 18, for example, a path which passes through the points (1,1), (2,3), (3,4), (5,5), (6,6) and (7,7) can be also drawn. This means that F2 in Frame A and F3 in Frame B are connected and that F3 in Frame A and F4 in Frame B are connected. F4 in Frame A and F2 in Frame B do not have counterparts to be connected with. It is considered that F4 in Frame A is a disappearing formant and F2 in Frame B is appearing one.

As has been described above, formant connection is determined depending on what path pattern is selected. The selection of a path pattern is made using a method for reducing a cost based on the distance between formant frequencies and the distance between formant bandwidths and a cost based on a shift from one grid point to another.

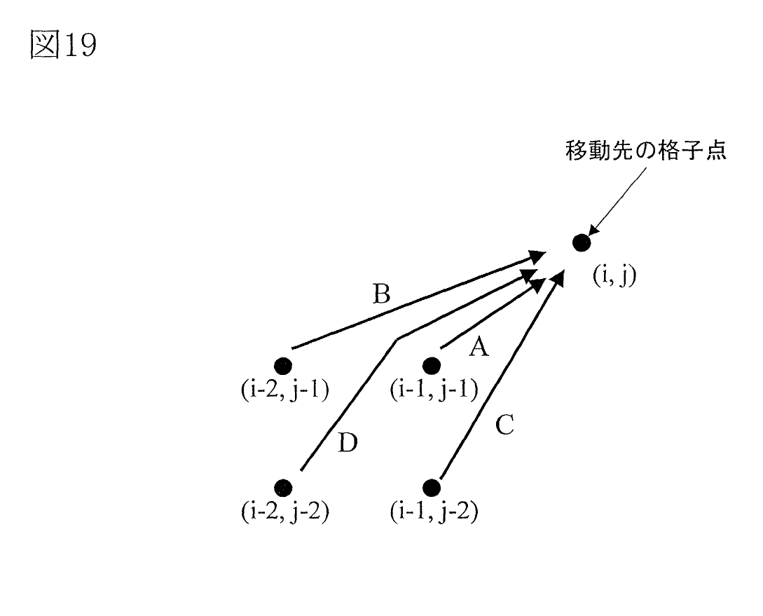

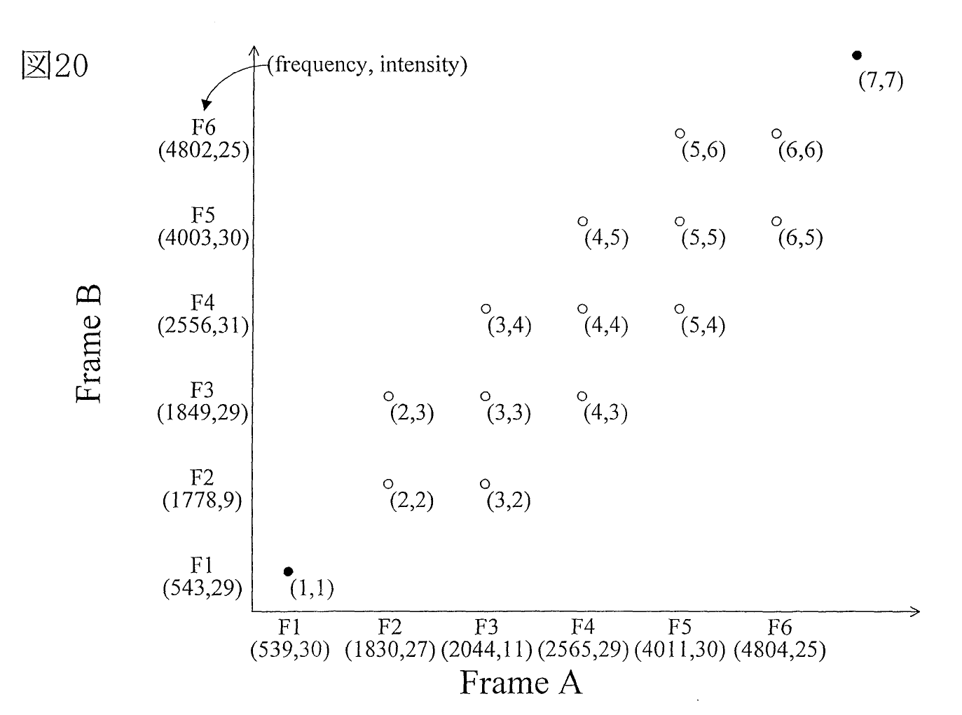

First, as shown in FIG. 19, a shift is constrained. Specifically, assume that only four points (i−1,j−1), (i−2,j−1), (i−1,j−2) and (i−2,j−2) can be shifted to the point (i, J). A shift from (i−1,j−1) is called A, a shift from (i−2,j−1)is called B, a shift from (i−1,j−2) is called C and a shift from (i−2,j−2) is called D. According to the constraints, grid points through which the path can pass during it starts at (1,1) and ends at (7,7), are obviously restricted to ones shown in FIG. 20 among all the grid points.

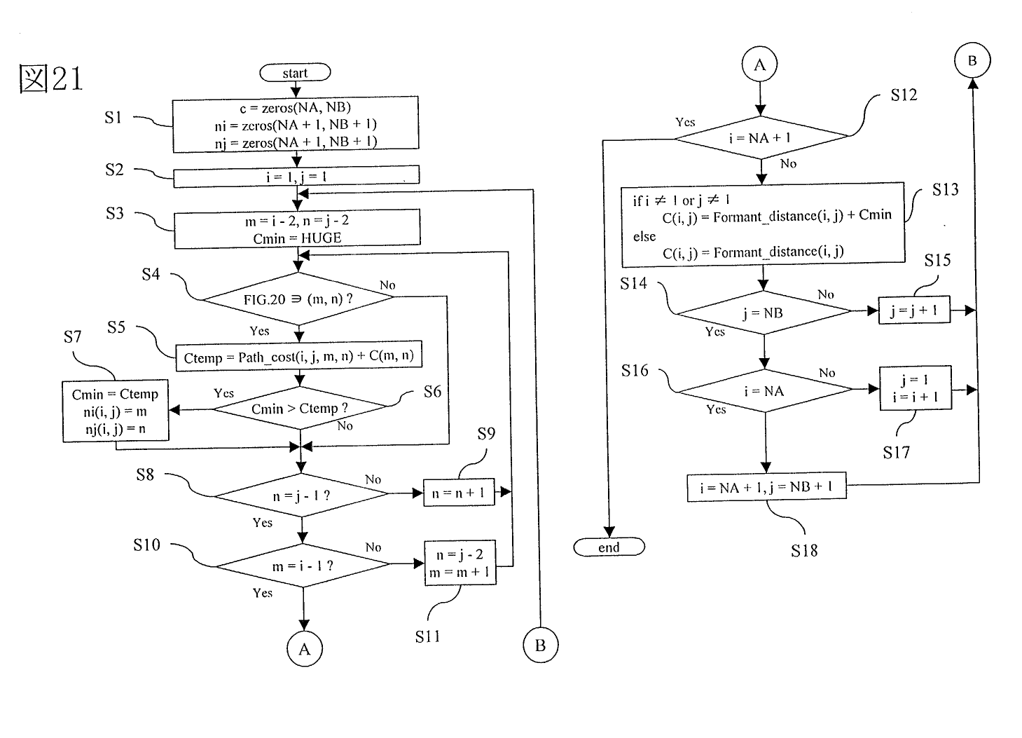

Hereinafter, the steps of path search will be described with reference to FIG. 21.

<Step S1>

First, the numbers of formants in Frame A and Frame B are set at NA and NB, respectively. An array C having a size of NA×NB and arrays ni and nj both having a size of (NA+1)×(NB+1) are prepared, and then elements of the arrays are all initialized to 0. C(i,j), which is the element of C, is used for storing the cumulative cost at the point (i,j). Also, ni(i,j), which is the element of ni, and nj(i,j), which is the element of nj, are used for storing a path which has been shifted at a minimum cumulative cost, i.e., an optimum path to the point (i,j). In other words, when the point right before the point (i,j) on the optimum path to the point (i,j) is a point (m,n), ni(i,j)=m and nj(i,j)=n hold.

<Step S2>

The cumulative costs and optimum paths for all possible grid points are calculated (see FIG. 20).

Both a counter i and a counter j are initialized to 1. i and j are used as the respective indexes of Frame A and Frame B.

<Step S3>

Cost calculation is made for four possible points (m,n) which can be shifted to the point (i,j) (see FIG. 19).

A counter m and a counter n are prepared and initialized to m=i−2 and n=j−2, respectively. Also, Cmin is prepared for calculating the minimum cumulative cost and previously replaced with as large a value as possible.

<Step S4>

If the point (m,n) is not contained in the set of possible grid points shown in FIG. 20, the process proceeds with Step S8. If it is so, the process proceeds with Step S5.

<Step S5>

Ctemp is prepared for temporarily storing a cumulative cost, and stores the sum of a path cost taken for shifting from point (m,n) to point (i,j) and the cumulative cost at the point (m,n).

<Step S6>

If Ctemp is smaller than Cmin (Yes), the process proceeds with Step S7. If not (No), the process proceeds with Step S8.

<Step S7>

Cmin is replaced with Ctemp, and m is stored in ni(i,j) and n in nj(i,j). ni(i,j) stores the Frame A coordinate at the point which has been shifted to the point (i,j) at a minimum cumulative cost, and nj (i,j) stores the Frame B coordinate at the same point.

<Step S8>

If n=j−1 holds (Yes), the process proceeds with Step S10. If not (No), the process proceeds with Step S9.

<Step S9>

n is incremented by 1 and then the process returns to Step S4.

<Step S10>

If m=i−1 holds (Yes), the process proceeds with Step S12. It not (No), the process proceeds with Step S11.

<Step S11>

n is set at j−2 again, m is incremented by 1 and then the process returns to Step S4.

<Step S12>

If i has reached NA+1 (Yes), the process ends. If not (No), the process proceeds with Step S13.

<Step S13>

The cumulative cost is stored in C(i,j). Specifically, stored therein are the sum of the formant distance at the point (i,j) (the value obtained according to Equation (26)) and Cmin. Note that since the point (1,1) is the starting point of the path, no path cost exists and thus only its formant distance is stored.

<Step S14>

If j has reached NB (Yes), the process proceeds with Step S16. If not (No), the process proceeds with Step S15.

<Step S15>

j is incremented by 1 and then the process returns to Step S3.

<Step S16>

If i has reached NA (Yes), the process proceeds with Step S18. If not (No), the process proceeds with Step S17.

<Step S17>

j is set at 1again, i is incremented by 1 and then the process returns to Step S3.

<Step S18>

Lastly, calculated is the point which will be shifted to the endpoint (NA+1, NB+1) at the minimum cumulative cost.

i=NA+1 and j=NB+1 are set and then the process returns to Step S3.

The path cost is calculated in the following manner. The number of allowed paths is four: A, B, C and D shown in FIG. 19. If the i^{th} formant in Frame A is expressed by FA(i) and the j^{th} formant in Frame B is expressed by FB(j), as for Path A, FA(i−1)is connected with FB(j−1) and FA(i) is connected with FB(j) and no disconnected formant exists. Therefore, the path cost (in other words, the disconnection cost) becomes 0. As for Path B, FA(i−1) does not have a counterpart to be connected with. In such a case, the path cost is calculated by substituting the intensity of FA(i−1) in Equation (27). As for Path C, in contrast, FB(j−1) does not have a counterpart to be connected with. Thus, the path cost is calculated by substituting the intensity of FB(j−1) in Equation (27). As for Path D, both FA(i−1) and FB(j−1) do not have counterparts to be connected with. Then, the path cost is the sum of the value obtained by substituting the intensity of FA(i−1) in Equation (27) and the value obtained by substituting the intensity of FB(j−1) in Equation (27).

It will be described how an actual cost is obtained using the calculations described above.

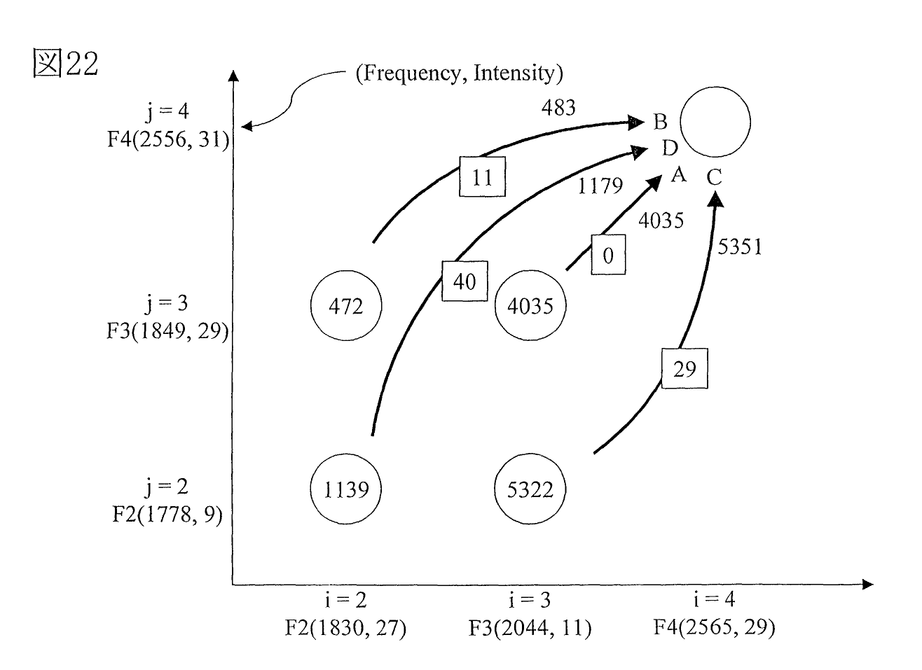

FIG. 22 illustrates the point (i,j) and four points (i−1,j−1), (i−2,j−1), (i−1,j−2) and (i−2,j−2) which can be shifted to the point (i,j). The arrows represent shifts from the four points to the point (i,j), and the path names A, B, C and D, which have been defined in FIG. 19, are indicated at respective point ends of the arrows. Also, in the circles which represent the four points, the respective cumulative costs at those points are indicated.

The numerals framed by square, each located in about the middle of the arrow which represents the path, indicate path costs. For example, the path cost of path B is calculated according to Equation (27) using the intensity of F3 in Frame A which has lost its counterpart to be connected due to the shift, and the calculation result becomes 11.

The respective cumulative costs (Ctemp which is calculated in Step S5) taken when the four points reach the point (i,j) through the corresponding four paths are indicated around the respective end points of the arrows. Specifically, the cumulative cost is a value obtained by adding a path cost taken for the shift to a cumulative cost at the point from which the shift originates.

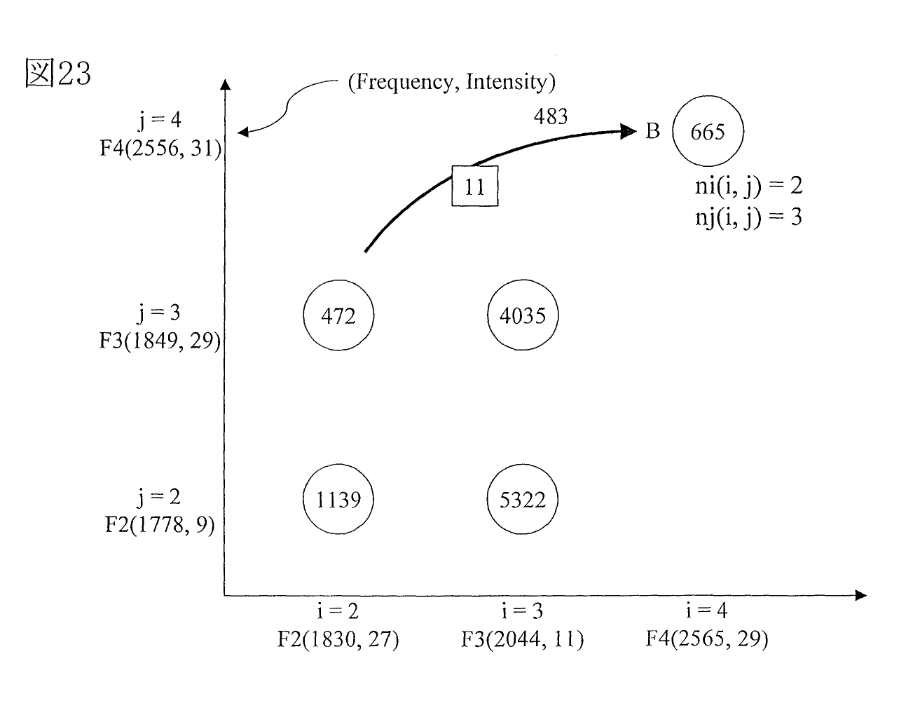

As a result, the cumulative costs 4035, 483, 5351 and 1179 are obtained for Paths A, B, C and D, respectively, and Path B having the smallest cumulative cost is selected (Step S7). FIG. 23 illustrates how path B has been selected. As Path B has been selected, the i coordinate at the starting point of Path B is stored in ni(i,j) and the j coordinate thereof is stored in nj(i,j). Also, at the point (i,j), 665 is indicated which is the cumulative cost obtained by adding 182 having been obtained by calculating the formant distance at the point (i,j) from Equation (26) to the cumulative cost based on Path B (Step S13).

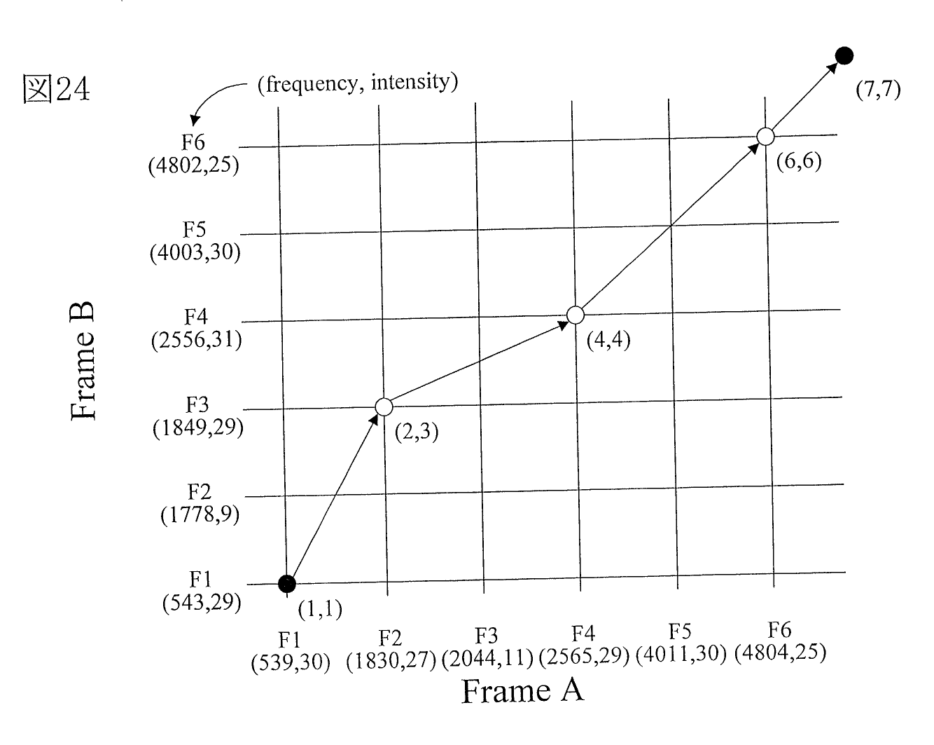

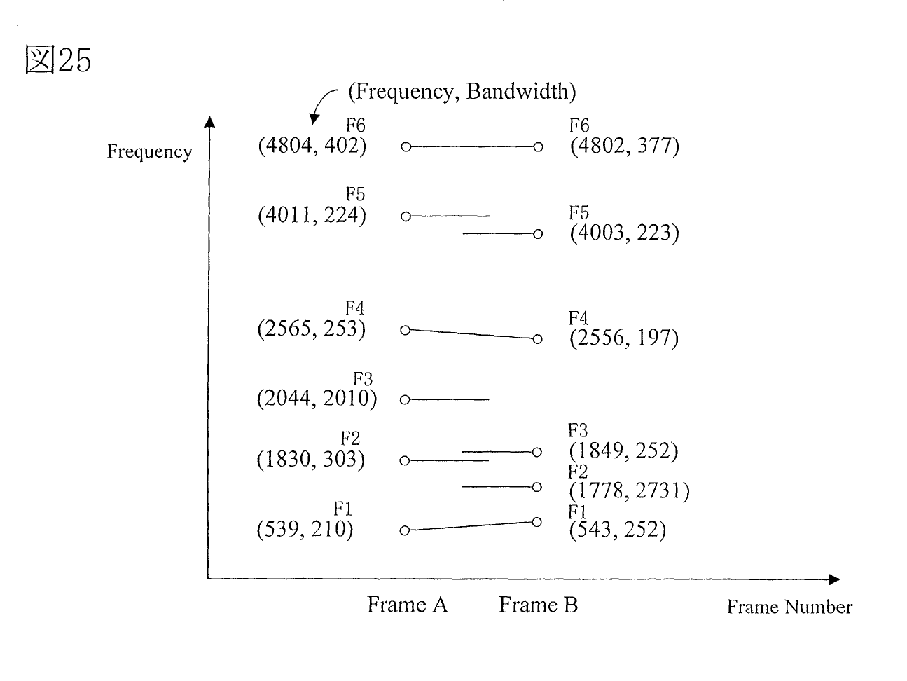

In this manner, partial optimum paths are consecutively obtained through respective cost calculations for every grid point on their way from (1,1) to (NA+1, NB+1). Thereafter, the aggregate optimum path from (1,1) to (NA+1, NB+1) can be obtained by tracing ni and ni from the end point to the starting point. The optimum path which has been obtained is indicated in FIG. 24. Also, it is illustrated in FIG. 25 how the formants shown in FIG. 15 are connected as a result of path search. As for formants which are connected with each other ilike F1 in Frame A and F1 in Frame B, the formant filters are smoothly changed with time. Since F2 in Frame A has no counterpart to be connected, the center frequency of its formant filter is not changed but the intensity is gradually changed to 0, to smoothly disappear. In contrast, as for F2 in Frame B, the intensity is gradually increased from 0, to smoothly appear.

In order to change the intensity smoothly, Fi is changed at a constant rate. By solving Equation (28) for Fb, the following equation is obtained.

$${F}_{b} ( n ) = \{ \begin{matrix}- \frac{{F}_{s}}{π} log ( \frac{{10}^{{F}_{s} ( n ) / 20} - 1}{{10}^{{F}_{i} ( n ) / 20} + 1} ) , if formant \\ - \frac{{F}_{s}}{π} log ( \frac{1 - {10}^{{F}_{s} ( n ) / 20}}{1 + {10}^{{F}_{i} ( n ) / 20}} ) , if anti \text{-} formant\end{matrix}$$

This equation may be used to transform Fi to Fb to calculate the filter coefficients.

As has been described, in the speech synthesis system according to the fifth embodiment, DP matching is used to carry out the optimum formant connection and thereby a disappearing formant and an appearing formant can be properly expressed.

Embodiment 6

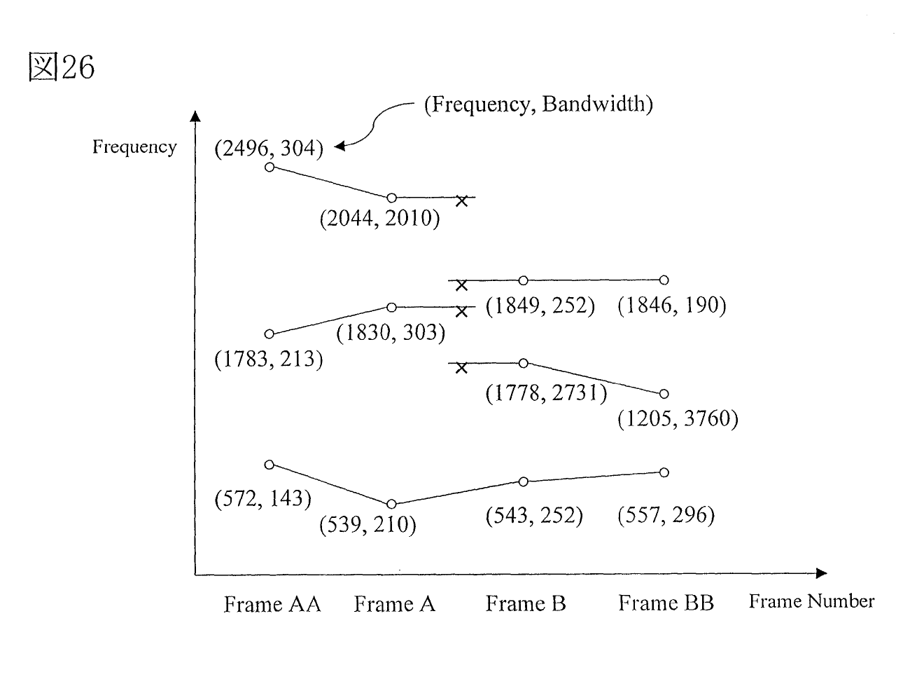

As has been described in the fifth embodiment, some formants are caused to disappear or appear, which requires to re-allocate formant filters in each frame. FIG. 26 shows Frame A and Frame B shown in FIG. 25 and frames around them. For the sake of simplicity, only F1 through F3 and their vicinity are shown. The four successive frames shown in FIG. 26 includes same Frame A and Frame B as shown in FIG. 25. The frames which have Frame A and Frame B therebetween are indicated as Frame AA and Frame BB. Between Frame A and Frame B, neither F2s nor F3s are connected according to the method described in the fifth embodiment. The disconnections are expressed by ×s in FIG. 26. It is understood that a disconnected formant either disappears toward a formant with the same frequency and a very low intensity or appears from such a formant.

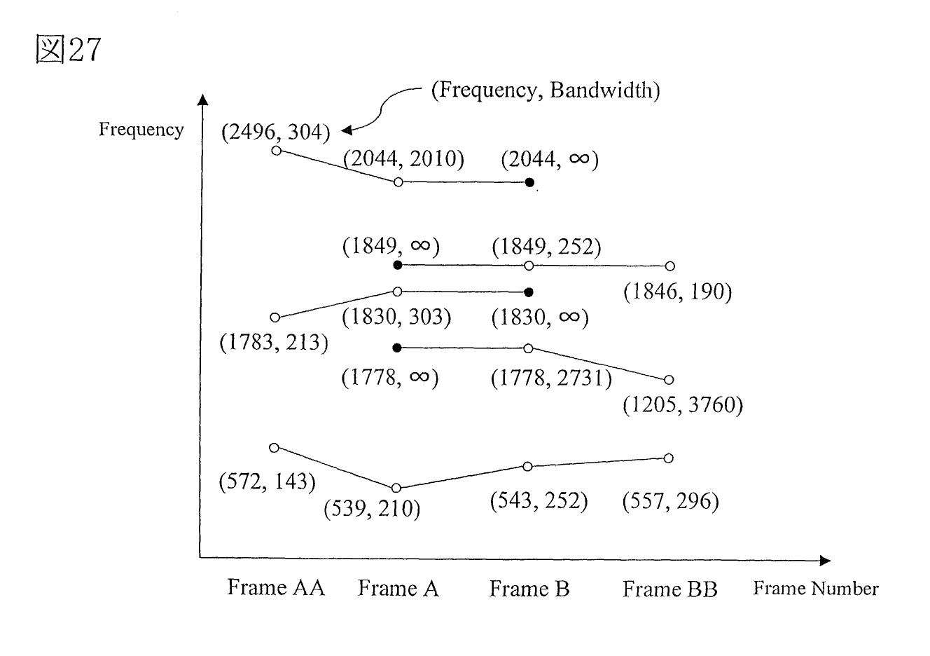

In order to embody the above concept, formants having no counterpart to be connected are connected with formants having an infinitely large bandwidth (i.e., an intensity of 0) as shown in FIG. 27. Black circles in FIG. 27 indicate the formants with an infinitely large bandwidth. By doing so, the filters can be smoothly changed while frequencies and bandwidths of formants are interpolated between Frame A and Frame B, and thereby a desired spectrum can be realized.

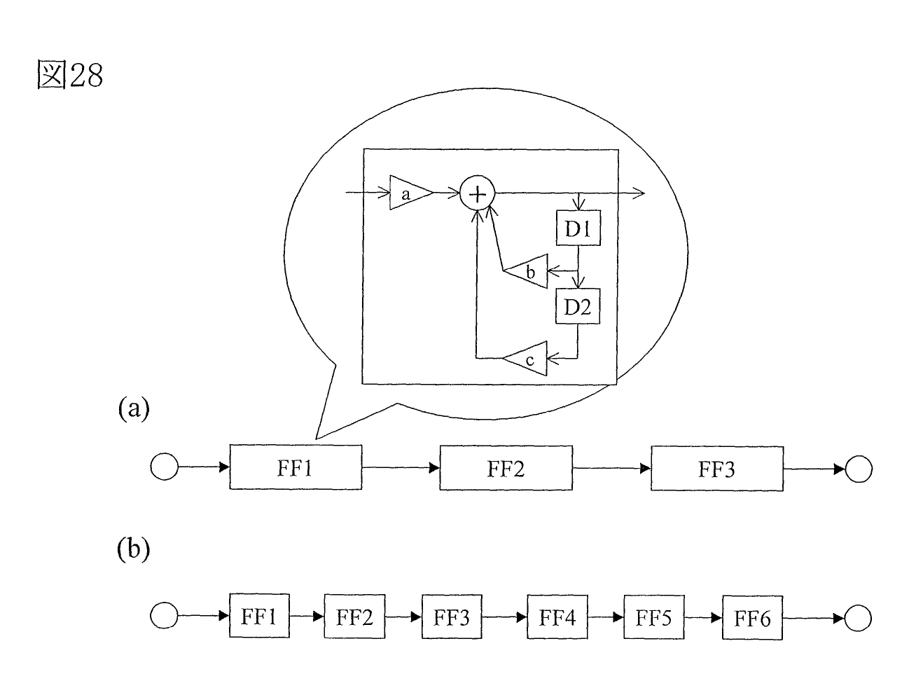

However, since Frame AA and Frame A are different in the number of formants from each other, a smooth filter change therebetween can not be realized by a simple interpolation. Frame AA and Frame BB are each implementable by cascade connection of three filters as shown in FIG. 28A. In FIG. 28, the formant filters are represented by FF1, FF2 and the like from the left. As for Frame A and Frame B, however, five filters have to be connected in cascade. Supposing that F1s are not connected with each other, six filters at most are connected in cascade. FIG. 28B illustrates the state of a cascade connection of six filters.

Here, for the sake of simplicity, quadratic mono-pole filters are used as the formant filters. In the upper part of FIG. 28, the inside of one of the filters is shown on an enlarged scale. D1 and D2 are delay elements which store a single-step vale. The transfer function is as follows:

$$h ( z ) = \frac{a}{1 + {bz}^{- 1} + {cz}^{- 2}}$$

F1 in Frame AA is straightly connected with F1 in Frame A but F2 in Frame AA is connected with F3 in Frame A. Therefore, in this case, allocation of the filters must be take into account. Thus, the six filters are kept connected in cascade at any time and the following steps are carried out during the period from Frame AA to Frame A.

(1) In Frame AA, since only three filters are needed, D1 and D2 are cleared to 0 at the filters FF4 through FF6, so that a=0, b=0and c=0 are obtained. Then, an equivalent state to the one where the filters are bypassed can be achieved. At FF1, FF2 and FF3, a, b, and care calculated from the respective frequencies and bandwidths of F1, F2 and F3.

(2) Between Frame AA and Frame A, the frequencies and the bandwidths are consecutively calculated according to the respective paths of connected formants and thereby filter properties are smoothly changed.

(3) At the point of Frame A, the allocation of formant filters is modified. FF1 in the previous frame is allocated to F1 in Frame A. Meanwhile, FF2 is allocated to F2 in Frame A. However, F2 in Frame AA is shifted to F3 at the point of Frame A. In Frame A, if FF2 is allocated to F2, filter coefficients abruptly change and therefore click noise is generated. Thus, a, band c which are the coefficients of FF2 in the previous frame and the values for D1 and D2 which represent their inside states are copied into FF3, and FF2 is allocated to F2 which has newly appeared.

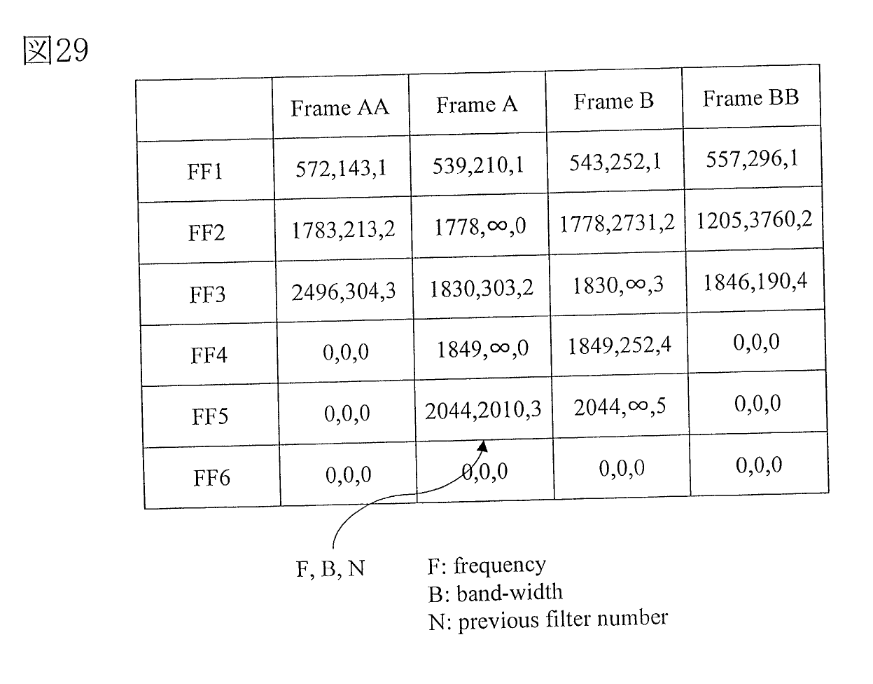

The operation shown above will be described more specifically with reference to FIG. 29.

FIG. 29 shows changes in configuration of formant filters in Frame AA, Frame A, Frame B and Frame BB. In each cell for formant filters, three numbers are indicated. The three numbers represent the formant frequency and the formant band width of a formant filter, and the number (connection number) of a counterpart in the previous frame which has been connected with the formant filter, respectively.

For example, the connection number of FF1 in Frame A is 1. This means that FF1 in Frame AA has been straightly connected with FF1 in Frame A. However, the connection number of FF3 in Frame A is not 3 but 2. This means that FF2 in Frame AA has been connected with FF3 in Frame A. Also, the connection number of FF2 in Frame A is 0, which indicates that no filter in Frame AA to be connected with FF2 in Frame A exists and therefore that FF2 is a formant which has newly appeared in Frame A. In Frame BB, no formant having the connection number 3 exists. This means that no counterpart to be connected with F3 in Frame B exists in Frame BB and that F3 in Frame B has disappeared. The formants, in which all the three numerical values are 0, are ones that does not need functions as a filter and will be bypassed, that is, the coefficients of the filter are a=1, b=0 and c=0.

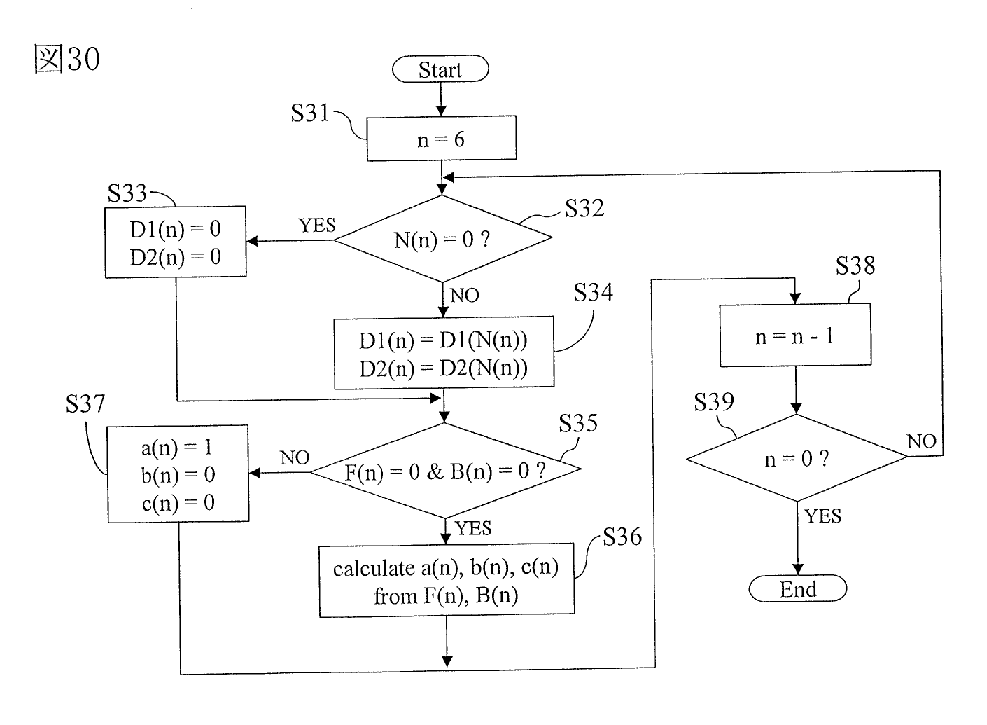

At the time when the state shifts from Frame AA to Frame A, the filters are re-allocated in accordance with the steps shown in FIG. 30.

Repeat from FF6 toward FF1 in order (Step S31 through Step S39)

if a connection number is 0 (Step S32)

clear D1 and D2 (Step S33).

else

assuming that the connection number is N, copy D1 and D2 of the Nth formant filter FFN.

endif

calculate a, b and c from formant frequency and bandwidth to set the resultant a, b and c (Step S36). Note that when formant frequency and bandwidth are both 0, a=1, b=0 and c=0 (Step S37).

finish repeating the steps.

As has been described above, since the speech synthesis system according to the sixth embodiment has a mechanism for modifying the configuration of a filter cascade connection according to the result of an optimum formant connection by DP matching, it is possible to smoothly reproduce a spectrum according to formants which have been optimally connected by DP matching, prevent generation of click noise and discontinuity of a waveform and therefore synthesize a smooth speech.

What is claimed is:

1. A speech synthesis system, which synthesizes speech using time series data of formant parameters (including a formant frequency and a formant bandwidth) estimated based on a speech production model, the speech synthesis system comprising determining the correspondence of formant parameters between adjacent frames using dynamic programming.

2. The speech synthesis system of claim 1, wherein in determining the correspondence of the formant parameters, a connection cost d_{c}(F(n), F(n+1)) and a disconnection cost d_{d}(F(k)) are obtained using the equations:
d_{c}(F(n),F(n+1))=α|F_{f}(n)−F_{f}(n+1)|+β|Fᵢ(n)−Fᵢ(n+1)|

$$\begin{matrix}{d}_{d} ( F ( k ) ) = α \vert {F}_{f} ( k ) - {F}_{f} ( k ) \vert + β \vert {F}_{i} ( k ) - ϵ \vert \\ = β \vert {F}_{i} ( k ) - ϵ \vert\end{matrix}$$
where α and β are predetermined weight coefficients, F_{f}(n) is a formant frequency in the n^{th} frame, that Fᵢ(n) is a formant intensity in the n^{th} frame and ε is a predetermined value, and the resultant d_{c}(F(n), F(n+1)) and d_{d}(F(k) )are used as costs for grid point shifting in dynamic programming.

3. The speech synthesis system of claim 2, wherein for two adjacent frames in which exists a formant which has no counterpart to be connected,
a formant having the same frequency as that of the disconnected formant in one of the frames and an intensity of 0 is located in the other frame and
the two adjacent frames are connected by interpolation of frequencies and intensities of both the formants according to a smooth function.

4. The speech synthesis system of claim 2, wherein the formant intensity Fᵢ(n) is calculated using
$${F}_{i} ( n ) = \{ \begin{matrix}20 {log}_{10} ( \frac{1 + {ⅇ}^{- π {F}_{b} ( n ) / {F}_{s}}}{1 - {ⅇ}^{- π {F}_{b} ( n ) / {F}_{s}}} ) , if formant \\ 20 {log}_{10} ( \frac{1 - {ⅇ}^{- π {F}_{b} ( n ) / {F}_{s}}}{1 + {ⅇ}^{- π {F}_{b} ( n ) / {F}_{s}}} ) , if anti \text{-} formant\end{matrix}$$
where F_{b}(n) is a formant bandwidth in the n^{th} frame and Fₛ is a sampling frequency.

5. The speech synthesis system of claim 3, wherein a vocal tract transfer function including a plurality of formants is implemented by a cascade connection of a plurality of filters and
wherein when a formant which has no counterpart to be connected exists in the adjacent frames and thus the connection of the filters needs to be changed,
a coefficient and an internally stored data of the filter in question are copied into another filter and
the first filter is then over written with a coefficient and an internally stored data of still another filter or initialized to predetermined values.

6. The speech synthesis system of claim 4, wherein a vocal tract transfer function including a plurality of formants is implemented by a cascade connection of a plurality of filters and
wherein when a formant which has no counterpart to be connected exists in the adjacent frames and thus the connection of the filters needs to be changed,
a coefficient and an internally stored data of the filter in question are copied into another filter and
the first filter is then over written with a coefficient and an internally stored data of still another filter or initialized to predetermined values.

7. A speech analysis method, in which a sound source parameter and a vocal tract parameter of a speech signal waveform are estimated by using a glottal source model including an RK voicing source model, the speech analysis method comprising the steps of:
extracting an estimated voicing source waveform using a filter which is constituted by the inverse characteristic of an estimated vocal tract transfer function;
estimating a peak position corresponding to a GCI (glottal closure instance) of the estimated voicing source waveform with higher accuracy at closer time intervals than that with the sampling period by applying a quadratic function;
synthesizing the GCI with a sampling position in the vicinity of the estimated peak position and thereby generating a voicing source model waveform; and
time-shifting the generated voicing source model waveform with higher accuracy at closer time intervals than that with the sampling period by means of all pass filters and thereby matching the GCI with the estimated peak position.

8. A speech analysis method, in which a voicing source parameter and a vocal tract parameter of a speech signal waveform are estimated by using a glottal voicing source model such as an RK model or a model defined as a modified model thereof, the speech analysis method comprising the steps of:
extracting an estimated voicing source waveform using filters which are constituted by the inverse characteristic of an estimated vocal tract transfer function; and
assuming the first harmonic level as H1 and the second harmonic level as H2 in DFT (discrete Fourier transformation) of the estimated voicing source waveform and estimating an OQ (open quotient) from a value for HD defined as HD=H2−H1.

9. The speech analysis method of claim 8, wherein for estimating the OQ, the relation:
OQ=3.65HD−0.273HD²+0.0224HD³+50.7
is used.
